(19) United States
(12) Patent Application Publication
(10) Pub. No.: US 2022/0191194 A1
(43) Pub. Date: Jun. 16, 2022

(54) IDENTITY-LINKED DEVICE INFORMATION FOR USER IDENTIFICATION AND TRANSACTION PERSONALIZATION VIA MOBILE TAGGING

(71) Applicant: Averon US, Inc., Henderson, NV (US)

(72) Inventors: Wendell Brown, Henderson, NV (US); Mark Klein, Henderson, NV (US)

(21) Appl. No.: 17/537,062

(22) Filed: Nov. 29, 2021

Related U.S. Application Data
(63) Continuation of application No. 16/389,388, filed on Apr. 19, 2019, now abandoned.
(60) Provisional application No. 62/659,861, filed on Apr. 19, 2018.

(51) Int. Cl. H04L 9/40; G06K 7/14; G06Q 20/34; H04W 4/029; H04W 12/64

(52) U.S. Cl. CPC H04L 63/0853; G06K 7/1417; H04W 12/64; H04W 4/029; G06Q 20/354; G06Q 20/355

(57) ABSTRACT

Embodiments of the present disclosure provide methods, systems, apparatuses, and computer program products for using identity-linked device information for user identification and transaction personalization via mobile tagging, for example validating user identity and providing a user identifier and user information for transaction personalization. A user identification and personalization system may be provided to receive an electronic data transmission, from a user device over a carrier network, indicative of prior execution of an access link having been detected and decoded from a decodable visual representation. The transmission may include identity-linked device information injected by a carrier device via a header enrichment process. The system may further determine a user identifier based on the identity-linked device information, and transmit, to the user device for forwarding to a service provider device, an authentication indication including the user identifier. The user identifier may be used for various identification/personalization applications.

### CROSS-REFERENCE TO RELATED APPLICATIONS

An Application Data Sheet is filed concurrently with this specification as part of the present application. Each application that the present application claims benefit of or priority to as identified in the concurrently filed Application Data Sheet is incorporated by reference herein in their entireties and for all purposes.

### TECHNOLOGICAL FIELD

Embodiments of the present disclosure relate, generally, user identification and transaction personalization via mobile tagging, and specifically, to improved individualized user identification and individualized transaction personalization using identity-linked device information.

### BACKGROUND

Mobile tagging enables visual codes to be scanned and decoded via a user device. Visual codes can be constructed to include targeted information associated with a targeted individual, but risk that non-targeted individuals may access the visual code and treated the same as the targeted individual. Applicant has discovered problems with current systems, methods, apparatuses, and computer program products for mobile tagging, and through applied effort, ingenuity, and innovation, Applicant has solved many of these identified problems by developing a solution that is embodied in the present disclosure, which is described in detail below.

### BRIEF SUMMARY

In general, embodiments of the present disclosure provided herein include systems, methods, apparatuses and computer readable media for using identity-linked device information for user identification and transaction personalization via mobile tagging.

Other systems, apparatuses, methods, computer readable media, and features will be, or will become, apparent to one with skill in the art upon examination of the following figures and detailed description. It is intended that all such additional systems, apparatuses, methods, computer readable media, and features be included within this description be within the scope of the disclosure, and be protected by the following claims.

In some embodiments, a user identification and personalization system may be provided for validating user identity based on identity-linked device information and providing a user identifier associated with the identity-linked device information for transaction personalization. The system may include at least one processor and at least one memory, the at least one memory having computer-coded instructions therein. The computer-code instructions, when executed by the processor, cause the user identification and personalization system to receive, via a carrier network, at the user identification and personalization system from a user device, an electronic data transmission, the electronic data transmission comprising identity-linked device information, the carrier network comprising at least a carrier device, the carrier device configured to inject the electronic data transmission with identity-linked device information via a header enrichment process, wherein the electronic data transmission is indicative of prior execution, by the user device identified by the identity-linked device information, of an access link having been detected and decoded from a decodable visual representation and having caused the user device to execute the access link. The system may further determine a user identifier based on the identity-linked device information. The system may further transmit, to the user device, an authentication indication comprising at least the user identifier, the authentication indication configured to cause the user device to forward the user identifier to a service provider device.

In some embodiments, the system is further configured to receive, from the service provider device, a user information query comprising at least the user identifier. In such embodiments, the system may be further configured to retrieve, from a user information repository, stored user information associated with the user identifier. IN such embodiments, the system may be further configured to transmit, to the service provider device, user information comprising at least a portion of the stored user information.

In some embodiments, the system is further configured to transmit, to at least one external information system, at least one external information request. In such embodiments, the system may be further configured to receive external user information from the at least one external information system in response to the at least one external information request. In such embodiments, the system may be further configured to transmit, to the service provider device, user information comprising at least a portion of the external user information.

In some embodiments, the system is further configured to retrieve a request-related device location associated with the user device. In such embodiments, the system may be further configured to identify a decodable location associated with the decodable visual representation. In such embodiments, the system may be further configured to determine whether the request-related device location is within a threshold distance from the decodable location. In such embodiments, the system may be further configured to identify user information based on the determination of whether the request-related device location is within the threshold distance from the decodable location. In such embodiments, the system may be further configured to transmit the user information to the service provider device in response to a user information query.

In some embodiments, to retrieve the request-related device location associated with the user device, the system is caused to retrieve, from the user device, a known device indication indicative of whether the user device is communicable with a known device, and determine the known device indication indicates the user device is communicable with the known device.

In some embodiments, the identity-linked device information comprises a mobile phone number associated with the user device, and the system is further caused to transmit, to device third-party device, a system contact number. In such embodiments, the system may be further configured to connect to the third-party device. In such embodiments, the system may be further configured to receive a service provider transaction number via the connection with the third-party device. In such embodiments, the system may be further configured to identify the identity-linked device information is associated with the service provider transaction number. In such embodiments, the system may be further configured to connect the third-party device to the user device using the identity-linked device information.

In some embodiments, the user device is associated with a user entity, the service provider device is associated with a service provider entity, and the system is further configured to cause the user device to generate a confirmation identifier for mailing, by the user entity associated with the user device, on a physical medium to the service provider entity associated with the service provider device. In such embodiments, the system may be further configured to retrieve a request-related device location associated with the user device. In such embodiments, the system may be further configured to receive, from the service provider device, the confirmation identifier in response to the service provider entity having received the physical medium. In such embodiments, the system may be further configured to identify, via a real-time postal service application programming interface associated with a postal service device, a mailed location associated with the mailing of the physical medium to the service provider entity. In such embodiments, the system may be further configured to determine whether the request-related device location is within a threshold distance from the mailed location. In such embodiments, the system may be further configured to identify user information based on the determination of whether the request-related device location is within the threshold distance from the mailed location. In such embodiments, the system may be further configured to transmit the user information to the service provider device in response to a user information query.

In some embodiments, the user device comprises a first user device, the service provider device comprises a second user device, and the system is further configured to receive, from the service provider device, a decodable authentication step rendering request in response to information indicating completion of a prior authentication step of a login process. In such embodiments, the system may be further configured to cause rendering, by the service provider device, of the decodable visual representation. In such embodiments, the system may be further configured to receive, from the service provider device, a verification request comprising the user identifier, wherein the verification request is received in response to scanning, by the user device, of the decodable visual representation. In such embodiments, the system may be further configured to transmit, to the service provider device, user information representing a verification message in response to the verification request, wherein the verification message causes the service provider device to continue the login process.

In some embodiments, the system is further configured to determine the identity-linked device information is associated with card information in an inactivated state. In such embodiments, the system may be further configured to cause the service provider device to activate the card information. In some of such embodiments, the system is further configured to cause the service provider device to associate the card information with the identity-linked device information for use via a payment service.

In some embodiments, the electronic data transmission further comprises a source identifier, and the system is further configured to cause the service provider device to associate the card information with the identity-linked device information for use via a payment service.

In some embodiments, the electronic data transmission further comprises a source identifier, and the system is further configured to authenticate the identity-linked device information matches the source identifier.

In some embodiments, a computer-implemented method may be provided for validating user identity based on identity-linked device information and providing a user identifier associated with the identity-linked device information for transaction personalization. The method includes receiving, via a carrier network, at the user identification and personalization system from a user device, an electronic data transmission, the electronic data transmission comprising identity-linked device information, the carrier network comprising at least a carrier device, the carrier device configured to inject the electronic data transmission with identity-linked device information via a header enrichment process, wherein the electronic data transmission is indicative of prior execution, by the user device identified by the identity-linked device information, of an access link having been detected and decoded from a decodable visual representation and having caused the user device to execute the access link. The method further includes determining a user identifier based on the identity-linked device information. The method further includes transmitting, to the user device, an authentication indication comprising at least the user identifier, the authentication indication configured to cause the user device to forward the user identifier to a service provider device.

In some embodiments, the method further includes receiving, from the service provider device, a user information query comprising at least the user identifier. In such embodiments, the method may further include retrieving, from a user information repository, stored user information associated with the user identifier. In some embodiments, the method may further include transmitting, to the service provider device, user information comprising at least a portion of the stored user information.

In some embodiments, the method further includes transmitting, to at least one external information system, at least one external information request. In such embodiments, the method may further include receiving external user information from the at least one external information system in response to the at least one external information request. In such embodiments, the method may further include transmitting, to the service provider device, user information comprising at least a portion of the external user information.

In some embodiments, the method further includes retrieving a request-related device location associated with the user device. In such embodiments, the method may further include identifying a decodable location associated with the decodable visual representation. In such embodiments, the method may further include determining whether the request-related device location is within a threshold distance from the decodable location. In such embodiments, the method may further include identifying user information based on the determination of whether the request-related device location is within the threshold distance from the decodable location. In such embodiments, the method may further include transmitting the user information to the service provider device in response to a user information query. In some of such embodiments, retrieving the request-related device location associated with the user device includes retrieving, from the user device, a known device indication indicative of whether the user device is communicable with a known device, and determining the known device indication indicates the user device is communicable with the known device.

In some embodiments, the identity-linked device information comprises a mobile phone number associated with the user device, and the method further includes transmitting, to device third-party device, a system contact number. In such embodiments, the method may further include connecting to the third-party device. In such embodiments, the method may further include receiving a service provider transaction number via the connection with the third-party device. In such embodiments, the method may further include identifying the identity-linked device information is associated with the service provider transaction number. In such embodiments, the method may further include connecting the third-party device to the user device using the identity-linked device information.

In some embodiments, the user device is associated with a user entity, the service provider device is associated with a service provider entity, and the method further includes causing the user device to generate a confirmation identifier for mailing, by the user entity associated with the user device, on a physical medium to the service provider entity associated with the service provider device. In such embodiments, the method may further include retrieving a request-related device location associated with the user device. In such embodiments, the method may further include receiving, from the service provider device, the confirmation identifier in response to the service provider entity having received the physical medium. In such embodiments, the method may further include identifying, via a real-time postal service application programming interface associated with a postal service device, a mailed location associated with the mailing of the physical medium to the service provider entity. In such embodiments, the method may further include determining whether the request-related device location is within a threshold distance from the mailed location. In such embodiments, the method may further include identifying user information based on the determination of whether the request-related device location is within the threshold distance from the mailed location. In such embodiments, the method may further include transmitting the user information to the service provider device in response to a user information query.

In some embodiments, the user device comprises a first user device, the service provider device comprises a second user device, and the method further comprises receiving, from the service provider device, a decodable authentication step rendering request in response to information indicating completion of a prior authentication step of a login process. In such embodiments, the method may further include causing rendering, by the service provider device, of the decodable visual representation. In such embodiments, the method may further include receiving, from the service provider device, a verification request comprising the user identifier, wherein the verification request is received in response to scanning, by the user device, of the decodable visual representation. In such embodiments, the method may further include transmitting, to the service provider device, user information representing a verification message in response to the verification request, wherein the verification message causes the service provider device to continue the login process.

In some embodiments, the method further includes determining the identity-linked device information is associated with card information in an inactivated state. In such embodiments, the method may further include causing the service provider device to activate the card information. In some of such embodiments, the method further includes causing the service provider device to associate the card information with the identity-linked device information for use via a payment service.

In some embodiments, the electronic data transmission further comprises a source identifier, and the method further includes authenticating the identity-linked device information matches the source identifier.

In some embodiments, a computer program product may be provided for validating user identity based on identity-linked device information and providing a user identifier associated with the identity-linked device information for transaction personalization. The computer program product includes at least one non-transitory computer readable storage medium having computer program instructions therein. The computer program instructions are configured to, when executed by a processor, cause the processor to receive, via a carrier network, at the user identification and personalization system from a user device, an electronic data transmission, the electronic data transmission comprising identity-linked device information, the carrier network comprising at least a carrier device, the carrier device configured to inject the electronic data transmission with identity-linked device information via a header enrichment process, wherein the electronic data transmission is indicative of prior execution, by the user device identified by the identity-linked device information, of an access link having been detected and decoded from a decodable visual representation and having caused the user device to execute the access link. The computer program instructions are further configured to determine a user identifier based on the identity-linked device information. The computer program instructions are further configured to transmit, to the user device, an authentication indication comprising at least the user identifier, the authentication indication configured to cause the user device to forward the user identifier to a service provider device.

In some embodiments, the computer program instructions are further configured to cause the processor to receive, from the service provider device, a user information query comprising at least the user identifier. In such embodiments, the computer program instructions may be further configured to cause the processor to retrieve, from a user information repository, stored user information associated with the user identifier. In such embodiments, the computer program instructions may be further configured to cause the processor to transmit, to the service provider device, user information comprising at least a portion of the stored user information.

In some embodiments, the computer program instructions are further configured to cause the processor to transmit, to at least one external information system, at least one external information request. In such embodiments, the computer program instructions may be further configured to cause the processor to receive external user information from the at least one external information system in response to the at least one external information request. In such embodiments, the computer program instructions may be further configured to cause the processor to transmit, to the service provider device, user information comprising at least a portion of the external user information.

In some embodiments, the computer program instructions are further configured to cause the processor to retrieve a request-related device location associated with the user device. In such embodiments, the computer program instructions may be further configured to cause the processor to identify a decodable location associated with the decodable visual representation. In such embodiments, the computer program instructions may be further configured to cause the processor to determine whether the request-related device location is within a threshold distance from the decodable location. In such embodiments, the computer program instructions may be further configured to cause the processor to identify user information based on the determination of whether the request-related device location is within the threshold distance from the decodable location. In such embodiments, the computer program instructions may be further configured to cause the processor to transmit the user information to the service provider device in response to a user information query. In some of such embodiments, the computer program instructions to retrieve the request-related device location associated with the user device cause the processor to retrieve, from the user device, a known device indication indicative of whether the user device is communicable with a known device, and determine the known device indication indicates the user device is communicable with the known device.

In some embodiments, the computer program instructions are further configured to cause the processor to transmit, to device third-party device, a system contact number. In such embodiments, the computer program instructions may be further configured to cause the processor to connect to the third-party device. In such embodiments, the computer program instructions may be further configured to cause the processor to receive a service provider transaction number via the connection with the third-party device. In such embodiments, the computer program instructions may be further configured to cause the processor to identify the identity-linked device information is associated with the service provider transaction number. In such embodiments, the computer program instructions may be further configured to cause the processor to connect the third-party device to the user device using the identity-linked device information.

In some embodiments, the user device is associated with a user entity, the service provider device is associated with a service provider entity, and the computer program instructions are further configured to cause the processor to cause the user device to generate a confirmation identifier for mailing, by the user entity associated with the user device, on a physical medium to the service provider entity associated with the service provider device. In such embodiments, the computer program instructions may be further configured to cause the processor to retrieve a request-related device location associated with the user device. In such embodiments, the computer program instructions may be further configured to cause the processor to receive, from the service provider device, the confirmation identifier in response to the service provider entity having received the physical medium. In such embodiments, the computer program instructions may be further configured to cause the processor to identify, via a real-time postal service application programming interface associated with a postal service device, a mailed location associated with the mailing of the physical medium to the service provider entity. In such embodiments, the computer program instructions may be further configured to cause the processor to determine whether the request-related device location is within a threshold distance from the mailed location. In such embodiments, the computer program instructions may be further configured to cause the processor to identify user information based on the determination of whether the request-related device location is within the threshold distance from the mailed location. In such embodiments, the computer program instructions may be further configured to cause the processor to transmit the user information to the service provider device in response to a user information query.

In some embodiments, the user device comprises a first user device, the service provider device comprises a second user device associated with the first user device, and the computer program instructions are further configured to cause the processor to receive, from the service provider device, a decodable authentication step rendering request in response to information indicating completion of a prior authentication step of a login process. In such embodiments, the computer program instructions may be further configured to cause the processor to cause rendering, by the service provider device, of the decodable visual representation. In such embodiments, the computer program instructions may be further configured to cause the processor to receive, from the service provider device, a verification request comprising the user identifier, wherein the verification request is received in response to scanning, by the user device, of the decodable visual representation. In such embodiments, the computer program instructions may be further configured to cause the processor to transmit, to the service provider device, user information representing a verification message in response to the verification request, wherein the verification message causes the service provider device to continue the login process.

In some embodiments, the computer program instructions are further configured to cause the processor to determine the identity-linked device information is associated with card information in an inactivated state. In such embodiments, the computer program instructions may be further configured to cause the processor to cause the service provider device to activate the card information. In some of such embodiments, the computer program instructions may be further configured to cause the processor to cause the service provider device to associate the card information with the identity-linked device information for use via a payment service.

In some embodiments, the electronic data transmission further comprises a source identifier, and the computer program instructions are further configured to cause the processor to authenticate the identity-linked device information matches the source identifier.

In some embodiments of the system, computer-implemented method, and/or computer program product, the authentication indication comprises a redirect link comprising the user identifier, where the redirect link is configured to cause the user device to transmit the user identifier to the service provider device.

In some embodiments of the system, computer-implemented method, and/or computer program product, the identity-linked device information comprises a mobile telephone number in a plaintext format or a hashed format.

In some embodiments, another user identification and personalization system may be provided for validating user identity based on identity-linked device information and providing a user identifier associated with the identity-linked device information for transaction personalization. The system may include at least one processor and at least one memory, the at least one memory having computer-coded instructions therein. The computer-code instructions, when executed by the processor, cause the user identification and personalization system to receive, via a carrier network, at the user identification and personalization system from a user device, an electronic data transmission, the electronic data transmission comprising identity-linked device information, the carrier network comprising at least a carrier device, the carrier device configured to inject the electronic data transmission with identity-linked device information via a header enrichment process, wherein the electronic data transmission is indicative of prior execution, by the user device identified by the identity-linked device information, of an access link having been detected and decoded from a decodable visual representation and having caused the user device to execute the access link; determine a user identifier based on the identity-linked device information; and transmit the user identifier to a service provider device.

In some embodiments, another computer-implemented method may be provided for validating user identity based on identity-linked device information and providing a user identifier associated with the identity-linked device information for transaction personalization. The method comprises receiving, via a carrier network, at the user identification and personalization system from a user device, an electronic data transmission, the electronic data transmission comprising identity-linked device information, the carrier network comprising at least a carrier device, the carrier device configured to inject the electronic data transmission with identity-linked device information via a header enrichment process, wherein the electronic data transmission is indicative of prior execution, by the user device identified by the identity-linked device information, of an access link having been detected and decoded from a decodable visual representation and having caused the user device to execute the access link; determining a user identifier based on the identity-linked device information; and transmitting the user identifier to a service provider device.

In some embodiments, another computer program product may be provided for validating user identity based on identity-linked device information and providing a user identifier associated with the identity-linked device information for transaction personalization. The computer program product includes at least one non-transitory computer readable storage medium having computer program instructions therein. The computer program instructions are configured to, when executed by a processor, cause the processor to receive, via a carrier network, at the user identification and personalization system from a user device, an electronic data transmission, the electronic data transmission comprising identity-linked device information, the carrier network comprising at least a carrier device, the carrier device configured to inject the electronic data transmission with identity-linked device information via a header enrichment process, wherein the electronic data transmission is indicative of prior execution, by the user device identified by the identity-linked device information, of an access link having been detected and decoded from a decodable visual representation and having caused the user device to execute the access link; determine a user identifier based on the identity-linked device information; and transmit the user identifier to a service provider device.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a system that may be specially configured within which embodiments of the present disclosure may operate;

FIG. 2 illustrates a block diagram of an example apparatus that may be specially configured in accordance with an example embodiment of the present disclosure;

FIG. 3 illustrates a data flow diagram depicting example data flow interactions between devices in accordance with an example embodiment of the present disclosure;

FIG. 4 illustrates a flowchart depicting various operations performed in an example process for authenticating a user identity associated with a user entity for a user device, and using identity-linked device information to enable user identification and transaction personalization in response to mobile tagging, in accordance with an example embodiment of the present disclosure;

FIG. 5 illustrates a flowchart depicting various operations performed in an example process for retrieving user information for use in providing transaction/experience personalization, in accordance with an example embodiment of the present disclosure;

FIG. 6 illustrates another flowchart depicting various operations performed in an example process for identifying appropriate user information for personalization based on a request-related device location and a decodable location, in accordance with an example embodiment of the present disclosure;

FIG. 7 illustrates a flowchart depicting various operations performed in an example process identifying appropriate user information for personalization based on a request-related device location and a mailed location associated with a mailed confirmation identifier, in accordance with an example embodiment of the present disclosure;

FIG. 8 illustrates a flowchart depicting various operations performed in an example process for performing a decodable authentication step of a login process via user information associated with identity-linked information received in response to mobile tagging, in accordance with an example embodiment of the present disclosure;

FIG. 9 illustrates a flowchart depicting various operations performed in an example process for activating card information associated with a newly received credit/debit card via a user identification and personalization system using identity-linked device information, in accordance with an example embodiment of the present disclosure; and

FIG. 10 illustrates a flowchart depicting various operations performed in an example process for connecting a third-party device to a user device via a user identification and personalization system using identity-linked device information without exposing personally identifying information, in accordance with an example embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

Mobile tagging encodes information into a two-dimensional barcode that is detectable and scannable/decodable by a user device (e.g., a mobile phone, tablet, laptop, and the like). Scanning the visual code decodes the stored information, which may be manipulated, displayed, and/or otherwise utilized by the user device. A decodable visual representation may be used to encode a universal resource identifier (URI), such that a user may access the URI by scanning the decodable visual representation. The Quick Response code (QR code) has been the most widely used decodable visual representation for mobile tagging, though various other types of decodable visual representations may be used.

QR codes have been used in a manner of contexts and displayed on a plurality of media (e.g., magazines, signs, buses, business cards, postal mailing, electronic screens, and in other environments where a user may desire additional information). QR codes may be displayed for a variety of reasons, including marketing applications. The convenience of scanning such decodable visual representations as opposed to requiring the URI to be provided manually increases the likelihood that a user will access the URI, and increases the rate at which user contact with an advertisement will convert into a sale.

QR codes (or other decodable visual representations) may thus be used in such general, non-personalized applications where all users access the same information. The stored information encoded into a QR code may further be personalized, for example by including personal information (a name, address, unique identifier, or the like) on marketing material directed specifically at a particular individual or group of individuals (e.g., a household or organization). Personalized QR codes may be associated with a personalized URI, for example, that is associated with accessing specific deal or promotion. For example, a pizza restaurant may offer a promotion for return-customers, and mail personalized promotional material including a personalized QR code encoding a personalized URI to each previous customer. However, because the QR codes are not securely personalized on an individual level, such personalization risks that non-targeted individuals who scan the personalized QR code may be treated the same as the intended recipient. For example, an unintended or malicious user may receive/intercept the personalized mailing from the pizza restaurant and scan the code to receive a discount despite not being the targeted individual user.

Personalizing the QR code (or other decodable visual representation) may present further risks depending on the stored information to be encoded by the QR code. For example, if a service provider may desire (or be required) to include personally identifiable information (PII) in the QR code. By doing so, the service provider may risk violating privacy regulations by including PII in the QR code. In this regard, decodable visual representations for mobile tagging are effective in providing information to one or more groups of users. The group of users may be targeted by medium and placement, but without additional infrastructure, such decodable visual representations cannot effectively and securely target individual users.

The identity of a user associated with a user device may be authenticated using identity-linked device information. Given the nature of user device possession, confirming possession and control of a user device associated with identity-linked device information serves as a proxy for confirming the identity of a user associated with the user device. An example of identity-linked device information is a mobile phone number with respect to a mobile phone. Mobile phones have become as ubiquitous as a wallet or a purse. A user generally keeps their mobile phone in close proximity and under their control. If the mobile phone is lost or stolen, the mobile phone is typically protected by a numeric passcode, pattern passcode, fingerprint, and/or another biometric characteristic of the user. A user may change their phone a number of times, for example due to loss, theft, upgrade, and the like, but not their mobile phone number is likely to remain the same. Confirming a mobile phone number associated with an accessed user device (e.g., where all passcode/access requirements have been met) thus serves as a proxy for identifying the user of that mobile device.

Embodiments of the present disclosure utilize identity-linked information received in response to a scanned decodable visual representation to provide, via a user identification and personalization system, improved user identification and transaction personalization. A user identification and personalization system may receive identity-linked device information from a user device, such as part of an electronic data transmission indicative that the user device scanned a decodable visual representation. The identity-linked device information may be received using a secure and trusted process, which may be controlled by a trusted third-party. For example, a user identification and personalization system may receive, from a user device over a carrier network using a header enrichment process, identity-linked device information embodied by a mobile phone number associated with the user device. The header enrichment process relies on the security built into the subscriber identity module (SIM) associated with the user device. The SIM is highly secure, as it is used by a carrier to positively identify the mobile phone number of a mobile device for billing purposes. When a user replaces a SIM for a device, such as replacing a SIM card, the user often retains their same mobile phone number. Thus, even though the hardware associated with the mobile phone device or the SIM card may change, the mobile phone number is still retained.

The user identification and personalization system may be sure the user is who they claim to be based on the veracity of the identity-linked device information. The user identification and personalization system may then be utilized for various identification and/or transaction personalization services/applications. For example, the user identification and personalization system may provide a verification message to a service provider device associated with a service provider entity to confirmation of the user's identity to the service provider device for two- or multi-factor authentication purposes (e.g., to access the service provider device). Additionally or alternatively, the user identification and personalization system may be used for various purposes without exposing personally identifiable information, such as identity-linked device information. For example, the user identification and personalization system may be used to connect a third-party device for a transaction associated with a service provider device (e.g., a mobile device associated with a delivery driver) with a user device (e.g., a mobile device associated with a purchaser of an item from a service provider device) using identity-linked device information representing a mobile phone number associated with the user device without exposing the identity-linked device information to the third-party device.

The user identification and personalization system may also be utilized to personalize transactions, experiences, information displays, and the like, to be accessed via a service provider device. For example, in some embodiments, a service provider device may retrieve personalized user information from the user identification and personalization system for various applications. The service provider device may provide a decodable visual representation that, when scanned by a user device via mobile tagging, enables the service provider device to, based on identity-linked device information, retrieve user information for personalizing a transaction specifically targeted for the user entity associated with the user device. For example, the service provider device may prepopulate one or more inputs for the user (e.g., a delivery location, a payment method, or the like) or derive information for personalizing one or more details of a transaction (e.g., a discount if the user entity is a returning customer) based on user information retrieved via the user identification and personalization system. For example, in some embodiments, when a user entity uses a user device to scan a decodable visual representation associated with a purchase transaction of a particular item or promotion, the user identification and personalization system can be used to pre-populate sufficient information such that the transaction can be completed with a single tap to confirm.

The user identification and personalization system enables the service provider device to tailor a personalized experience, promotion, transaction, or the like, to an individual level regardless of placement of a decodable visual representation. For example, if a decodable visual representation is placed in a public location (e.g., accessible by one or more user entities) associated with a transaction for buying an item, the transaction may still be personalized for each individual user entity that scans the decodable visual representation using identity-linked device information. The user identification and personalization system may provide user information to a service provider device in response to a query by the user identification and personalization system for such user information. The user information may be provided to cause the service provider device to utilize the user information to personalize an experience, website, product offering, information display, or the like, to be transmitted to the user device. For example, user information may be used to prepopulate transaction fields, alter promotional offerings, adjust a webpage or other informational display, and the like.

In some embodiments, the user information provided by the user identification and personalization system may be limited based on a request-related device location representing the location of the user device when scanning a decodable visual representation. For example, a default shipping location may pre-populated if the user device is at a common location (e.g., if the user device is located at the home address for the user entity). Such personalization may also prevent the risk of fraud associated with pre-populated transactions. For example, user information representing payment methods may only be pre-populated if the user device is located at a trusted location (e.g., a home address associated with the user entity).

Some embodiments may utilize different decodable visual representations for different item transactions. For example, a service provider entity may provide a mailing to a location associated with a user entity, where the mailing has a plurality of decodable visual representations, each associated with an instant order of a particular item (e.g., ordering items from a menu or catalog). Each of the customized decodable visual representations may be configured to be associated with a different item, and each scanned decodable visual representation may be associated with a personalized transaction that is based on user information specific to the user device that scanned the decodable visual representation based on identity-linked device information for the user device.

In some embodiments, the user identification and personalization system may communicate with various remote devices to retrieve information of various types. For example, in addition to the service provider device and external information systems, in some embodiments the user identification and personalization system may communicate with one or more postal service devices. A postal service device may be communicated with via a real-time postal service application programming interface to obtain, for example, information regarding mailing of physical media including decodable visual representations. For example, the user identification and personalization system may communicate with a postal service device to determine a delivery date and time of a mailing including a decodable visual representation. Based on the delivery date and/or time, the user identification and personalization system may be able to determine conversion time statistics associated with when a user entity receives a mailing including a decodable visual representation, and when the user entity scans the decodable visual representation via a user device. Such conversion time statistics can be used to determine effectiveness of mailings having certain decodable visual representations. The delivery date and time may also be used to confirm, supplement, and or change user information provided to the service provider device for transaction personalization. For example, the user identification and personalization system may facilitate a special promotion/offer based on the delivery date and time. For example, if the delivery date and time indicates the user entity has just received the mailing, the user identification and personalization system may identify user information for facilitating a particular deal for the next 24 hours (e.g., by setting a special price for an item if the transaction is completed within the time period, such as “get free fries if you order this item within 1 day of receiving the mailing.”).

Additionally or alternatively, a user entity may mail a confirmation identifier associated with a received mailing from the service provider entity, and a postal service device may be accessed to determine a mailed location where the user entity mailed the confirmation identifier. The user identification and personalization system may utilize the mailed location to determine if the user entity is associated with an expected user entity location, and provide an authentication message if so.

Promotion/advertising campaigns, for example, utilizing decodable visual representations are not just limited to physical mailings or placement. Decodable visual representations may be digitally presented via rendering to a screen (e.g., a television, monitor, phone display, or the like). Each digitally presented decodable visual representation may be associated with a campaign number for measuring the conversion rate of the digitally presented decodable visual representations.

The user identification and personalization system may provide another personalized experience/application to perform confirmation of receipt of a new credit/debit card, and/or activate the new credit/debit card. Additionally or alternatively, the user identification and personalization system may be configured to, after verifying the user identity based on identity-linked device information, enroll card information for use by the user device in a payment service based on the user device or the identity-linked device information. After enrollment, the specific credit card may be validated for purchase associated with the user device/identity-linked device information (e.g., such as a mobile phone number). In some embodiments, a location check may be performed to prevent fraudulent actions. For example, a request-related device location may be retrieved associated with the user device, and compared to a known or expected location associated with the user (e.g., a mailed location or a home address), such that the card activation process only occurs when the user device is within a threshold range of the known/expected location.

The user identification and personalization system may also facilitate a contest, sweepstakes, drawing, or other random-selection/change event. For example, the user identification and personalization system may identify a user identity associated with a user device using a header enrichment process. User information may then be generated and/or provided by the user identification and personalization system indicating whether the user entity associated with the identity-linked device information has won. For example, the service provider device and/or user identification and personalization system may generate

Another personalized experience the user identification and personalization system may be configured to facilitate is an authentication/login procedure associated with a service provider device. For example, the user identity and personalization system may authenticate the user using highly-secure identity-linked device information, for example transmitted via a header enrichment process in response to scanning a decodable visual representation. A service provider device may rely on this authentication such that a user may be authenticated immediately without performing additional authentication steps. The authentication process may similarly be used when the service provider device accepts payment associated with a transaction between the service provider device and a user device.

### Definitions

The term “user device” refers to hardware and/or software that is configured to interact with a service provider device and a user identification and personalization system. In some embodiments, a user device interacts with a service provider device and/or user identification and personalization system via one or more networks. User devices may include any known computing devices such as, without limitation, mobile phones, smart phones, tablet computers, laptop computers, wearables, personal computers, enterprise computers, and the like.

The terms “user entity” and “user” refer to an individual, corporation, group, or other entity associated with and/or controlling a particular user device. An example of a user entity is a mobile phone owner where the user device is the mobile phone.

The term “identity-linked device information” refers to information associated with a user device that functions as a proxy for identification of the user entity associated with the user device. In some embodiments, identity-linked device information is injected into a transmission from a user device to a user identification and personalization system by a carrier device associated with a carrier network, or another third-party device/system. In some embodiments, identity-linked device information comprises a mobile phone number in plaintext or hashed format.

The term “carrier network” refers to a telecoms network infrastructure provided by a telecoms service provider (“carrier”). In some embodiments, a user device is configured to communicate via a carrier network associated with a carrier entity facilitating communication services for the user device.

The term “carrier device” refers to hardware, software, and/or a combination there, embodying a component of a carrier network. In some embodiments, a carrier device is configured to perform header enrichment. In some embodiments, the carrier device is a server controlled by a carrier.

The terms “carrier header enrichment,” “packet header enrichment,” and “header enrichment process” refer to a process for authenticating a mobile device or an owner of the mobile device via a Direct Autonomous Authentication process, involving a packet header enrichment in which packet headers comprise device identification information, for example, “injected” therein by a trusted party, such as a carrier via a carrier device, network provider or through a login process. For example, in some embodiments, a network may inject a mobile phone number associated with a mobile device within packet headers of a transmission. In this manner, the device-identity management system may obtain device-identity information associated with a user device and associated with the user of the user device without user input. Application Ser. No. 15/424,595, entitled “Method and Apparatus for Facilitating Frictionless Two-Factor Authentication,” filed on Feb. 3, 2017, which is hereby incorporated by reference in its entirety, describes a number of exemplary processes for performing a Direct Autonomous Authentication process.

The term “service provider device” refers to hardware and/or software that is configured to provide one or more services to a user device. The services provided are personalized via communication with a user identification and personalization system. In some embodiments, a service provider device interacts/interfaces with a user device and/or a user identification and personalization system via one or more networks. Service provider devices may include any known computing devices, including, without limitation, servers, mobile terminals, personal computers, enterprise computers, and the like, or a combination thereof.

The term “service provider entity” refers to an individual, corporation, group, or other entity associated with and/or controlling a particular service provider entity. A service provide entity enables the provision of services to user entities via one or more service provider device(s) communicating with one or more client device(s).

The term “user identification and personalization system” refers to hardware and/or software for verifying user identity associated with a user device and providing or enabling the provision of personalized services to the user device via a service provider device. In some embodiments, a user identification and personalization system is further configured to store and retrieve user information using a user information repository. In some embodiments, a user identification and personalization system is configured to retrieve user information. In some embodiments, a user identification and personalization system is configured to communicate with a user device, service provider device, and/or one or more external information systems via one or more networks. For example, in some embodiments a user identification and personalization system is configured to communicate with a user device and/or a carrier device via a carrier network, and communicate with a service provider device and/or other device/systems via a second communications network (e.g., the Internet).

The term “authentication indication” refers to electronic data transmitted from a user identification and personalization system that indicates a user device has been authenticated as associated with identity-linked device information received via a secure process. For example, an authentication indication in some embodiments indicates that the user identity was authenticated by receiving the identity-linked device information via a header enrichment process. In some embodiments, an authentication indication includes at least a user identifier associated with identity-linked device information and/or user information.

The term “access link” refers to an interface component and/or corresponding information detected and decoded in response to scanning a decodable visual representation, and configured to facilitate transmission of an electronic data transmission from a user device to a user identification and personalization system. An access link is configured associated with a predefined URI, embedded in a decodable visual representation, for accessing an endpoint device, such as a carrier device, within the user identification and personalization system or configured to forward information to the user identification and personalization system. In some embodiments, an access link is configured to cause transmitting of an electronic data transmission (defined below) from the user device to a user identification and personalization system. In some embodiments, an access link is associated with a carrier device, such that accessing the access link terminates at the carrier device within the carrier network for performing a header enrichment and further forwarding to the user identification and personalization system. In other embodiments, an access link terminates transmission of an electronic data transmission at a carrier device within the user identification and personalization system, or otherwise associated with the user identification and personalization system such that the user identification and personalization system is configured to access the electronic data transmission without forwarding by the carrier device. In some embodiments, the access link is an HTTP or HTTPS GET request.

The term “electronic data transmission” refers to an electronically managed information package for transmission from a user device to a user identification and personalization system over a carrier network in response to engagement of an access link decoded from a decodable visual representation. In some embodiments, an access link is automatically engaged (e.g., it is automatically launched via a browser application on the user device). In some embodiments, user engagement of the access link occurs via a user entity. In some embodiments, an electronic data transmission includes a source identifier decoded by the user device from a decodable visual representation. Additionally or alternatively, in some embodiments an electronic data transmission has identity-linked device information injected into it by a carrier device within the carrier network via a header enrichment process.

The term “user identifier” refers to a string, number, or other information that uniquely identifies information associated with received identity-linked device information stored by a user identification and personalization system and/or service provider device. In some embodiments, a user identifier for identity-linked device information is generated and/or stored by a user identification and personalization system based on the identity-linked device information. In some embodiments, a user identifier comprises the identity-linked device information. For example, in some embodiments a user identifier is a mobile phone number.

The term “user information” refers to electronically managed data associated with a user device, and/or user entity, associated with particular identity-linked device information and/or a corresponding user identifier, or that represents a resulting determination performed by a user identification and personalization system. In some embodiments, user information is collected from one or more sources and includes one or more types of information. Examples of user information include, but are not limited to: name data, address data, customer-specific account data, historical transaction data, user preference data, credit data, customer-specific data, demographic data, psychographic data, and/or behavioral data. In some embodiments, user information includes a subset of information derived from other user information. For example, user information may include a returning customer indicator derived based on a transaction history or derived based on whether corresponding service provider user information exists (e.g., whether a service provider device has information stored associated with a certain user identifier or identity-linked device information.

In some embodiments, different user information is stored by different devices. For example, “stored user information” refers to user information stored by a user identification and personalization system in a user information repository. “Service provider user information” refers to user information stored by a service provider device. “External user information” refers to user information stored by an external information system.

The term “external information system” refers to a device, hardware, component, or other hardware not operated or controlled by the user identification and personalization system. In some embodiments, the user identification and personalization system communicates with an external information system via a network. Examples of external information systems include, but are not limited to, credit reporting agency systems/devices, advertising aggregator systems/devices, carrier systems/devices, and the like.

In some embodiments, the user identification and personalization system is configured to retrieve user information from an external information system in response to transmitting an “external information request.” An external information request may include identity-linked device information, a user identifier, or other information associated with the user device and/or user entity.

The term “user information query” refers to an electronic message transmitted from a service provider device to a user identification and personalization system, the message indicative of a request to receive user information from the user identification and personalization system. In some embodiments, the user information query includes a user identifier for retrieving associated user information (1) directly from the user identification and personalization system or (2) from one or more external information systems via the user identification and personalization system.

The term “redirect link” refers to a specific interface component and/or corresponding connection information transmitted from a user identification and personalization system to a user device to cause the user device to access a service provider device. The redirect link is associated with a URI associated with the service provider device. In some embodiments, a redirect link is transmitted in response to successfully receiving and/or authenticating identity-linked device information from the user device. In some embodiments, a redirect link includes identity-linked device information, an associated user identifier, and/or associated user information. A redirect link may be configured to cause the user device to automatically execute the redirect link to access the service provider device for forwarding information, such as the user identifier, to the service provider device. A redirect link may, for example, be executed via a browser application on the client device.

The term “location” or “location data” refers to a geographic area associated with a device. Examples of locations include, but are not limited to, latitude and longitude coordinate, Global Positioning Satellite (GPS) location, address, zip code, predefined area, relative location (e.g., with respect to another location), or a combination thereof.

The term “request-related device location” refers to a location associated with a user device, in real-time or near real-time, when a user identification and personalization system receives identity-linked device information from the user device. In some embodiments, a request-related device location is retrieved from the user device using location services components. In other embodiments, the request-related device location is retrieved from one or more third-party devices through various location calculations (e.g., triangulation using cell towers).

The term “decodable location” refers to a known location associated with the posting, mailing, and or intended scanning location of a decodable visual representation. In some embodiments, a decodable location is an address associated with a mailing including a decodable visual representation. In some embodiments, a decodable location is a home location, work location, or other important and/or commonly visited location associated with a targeted user entity associated with a user device.

The term “threshold distance” refers to a predefined or dynamic range within which a first location must be with respect to a second location to be determined as likely not fraudulent. For example, in some embodiments, a threshold distance of 25 miles may be utilized, such that a first location does not satisfy a threshold distance if it is more than 25 miles from a second location.

The term “known device” refers to a system, component, or device accessed by and/or otherwise associated with the user device that is external to the user device. Examples of a known device include, but are not limited to, a prior known Wi-Fi enabled device, prior known Bluetooth enabled device, and prior known “Internet of Things” enabled device. A known device may be associated with a particular location where the known device is located.

The term “known device indication” refers to an indication that a user device is within a threshold distance from a known device indication. In some embodiments, a user identity and personalization system may identify and/or retrieve a known device indication from the user device to determine whether the user device is currently communicable with a known device. In some embodiments, a known device indication includes a location associated with the known device.

The term “decodable visual representation” refers to a two-dimensional visual representation of information and/or data that is configured to be detected and/or decoded by a user device. In some embodiments, a decodable visual representation is presented via a physical medium (e.g., printed on an item). In some embodiments, decodable barcode is presented via a digital medium (e.g., rendered to a screen, monitor, television or the like). Examples of a decodable barcode include, but are not limited to, a QR code, bar code, or other scannable code.

The term “source identifier” refers to a unique string, value, text, data, or information that uniquely identifies a specific presentation or instance of a decodable visual representation. In some embodiments, a source identifier is encoded as part of the decodable visual representation. An example of a source identifier includes, but is not limited to, a string to uniquely identify the address to which a post card including decodable visual representation is sent (e.g., an identity corresponding to the address to which a mailing was sent, known to the user identification and personalization system).

The term “system contact number” refers to a telephone number for accessing the user identification and personalization system for connecting to a user device. The user identification and personalization system may receive a “user device contact request” in response to a third-party device accessing the system contact number (e.g., by calling the system contact number). In some embodiments, the user identification and personalization system is configured to connect the third-party device to a user device in response to the received user device contact request. Additionally or alternatively, the user identification and personalization system receives additional information from the third-party device before connecting the third-party device to a user device.

The term “service provider transaction number” refers to a third-party device provided identifier that uniquely represents a transaction associated with a particular user entity. In some embodiments, a service provider transaction number is uniquely associated with identity-linked device information for the particular user entity. In some embodiments, the user identification and personalization system utilizes the service provider transaction number to identify identity-linked device information to use to connect the third-party device to a user device associated with the identity-linked device information, where the identity-linked device information is a mobile phone number.

The term “confirmation identifier” refers to a predefined, random, or pseudo-random code generated by a user device after receiving information indicating that the user device was authenticated with identity-linked device information (e.g., when the user device receives a user identifier from the user identification and personalization system). In some embodiments, confirmation identifier is to be written and/or otherwise printed on a physical medium and mailed to a service provider entity. The confirmation identifier may be utilized by a service provider device, and/or a user identification and personalization system, to determine a mailing location associated with the mailed physical medium. Examples of physical media include, but are not limited to, paper, postcards, letters, and the like.

The term “real-time postal service application programming interface” refers to a system of tools managed by a postal service device for accessing third-party hosted postal service information in real-time. A real-time postal service application programming interface enables real-time retrieval of information associated with the mailing, shipping, and/or other delivery of mailings. In some embodiments, a real-time postal service application programming interface is configured to receive a confirmation identifier and provide a mailed location corresponding to a mailed physical medium associated with the confirmation identifier. Additionally or alternatively, a real-time postal service application programming interface may be used to retrieve a delivery status and/or a delivery date/time (if delivered) for a particular mailing.

The term “postal service device” refers to hardware, a component, or a device managed, operated by, or controlled by a postal service for maintaining and otherwise making accessible one or more postal service application programming interfaces. In some embodiments, a postal service device is entirely controlled by a postal service entity. In other embodiments, a postal service device is controlled by a third-party entity and managed by the postal service (e.g., over a network).

The term “mailed location” refers to a specific location where a mailing was deposited to a postal service entity for mailing. In some embodiments, a mailed location represents a post office or drop box.

The term “login process” refers to a series of authentication steps to be performed for authenticating a user identity for accessing a device, such as a service provider device. In some embodiments, a user device or service provider device is secured with a login process, such that a user cannot access the user device or service provider device without first completing the login process. In some embodiments, a login process includes a primary authentication step and a two-factor authentication step. In other embodiments, a login process includes a primary authentication step and multiple multi-factor authentication steps.

The term “primary authentication step” refers to an initial step in a login process. In some embodiments, the primary authentication step includes authenticating a user entered username and password.

The term “decodable authentication step rendering request” refers to electronic data, received from a service provider device, requesting information associated with a decodable visual representation for rendering to the service provider device. In some embodiments, a decodable authentication step rendering request is received after completion of a previous authentication step, and at the beginning of a “decodable authentication step.” During a decodable authentication step, a user entity may be required to scan a decodable visual representation rendered in response to a decodable authentication step rendering request for authentication via a verification message.

The term “verification request” refers to information received from a service provider device indicative that the service provider is a second user device requesting two-factor or multi-factor confirmation of the user's identity via a user identification and personalization system. In some embodiments, the user identification and personalization system provides a “verification message” (either directly or through a first user device) to the service provider device upon successfully authenticating the first user device is associated with the service provider/second user device.

The term “card information” refers to credit card and/or debit card information, including a primary account number, card holder name, expiration date, card verification value (CVV), and the like. In some embodiments card information, or a subset thereof, is used to uniquely identify a credit/debit card.

The term “inactivated state” refers to a usability status with regard to a credit/debit card having particular card information. If a credit/debit card is in an inactivated state, the card cannot be utilized. Activating card information refers to changing the state associated with the card information from an inactivated state to an activated state, such that the credit/debit card may be processed.

The term “payment service” refers to a payment method digitally managed by a service provider device for purchasing, via a user device, utilizing one or more credit and/or debit cards authorized for use. In some embodiments, a payment service is a mobile payment service enabling a user entity to complete a purchase using a user device embodying a mobile phone. Examples of payment services include Apple Pay®, Google Pay™, and the like.

### System Architecture and Example Apparatus

The methods, apparatuses, systems, and computer program products of the present disclosure may be embodied by any variety of devices. For example, a method, apparatus, system, and computer program product of an example embodiment may be embodied by a fixed computing device, such as a personal computer, computing server, computing workstation, or a combination thereof. Further, an example embodiment may be embodied by any of a variety of mobile terminals, mobile telephones, smartphones, laptop computers, tablet computers, or any combination of the aforementioned devices.

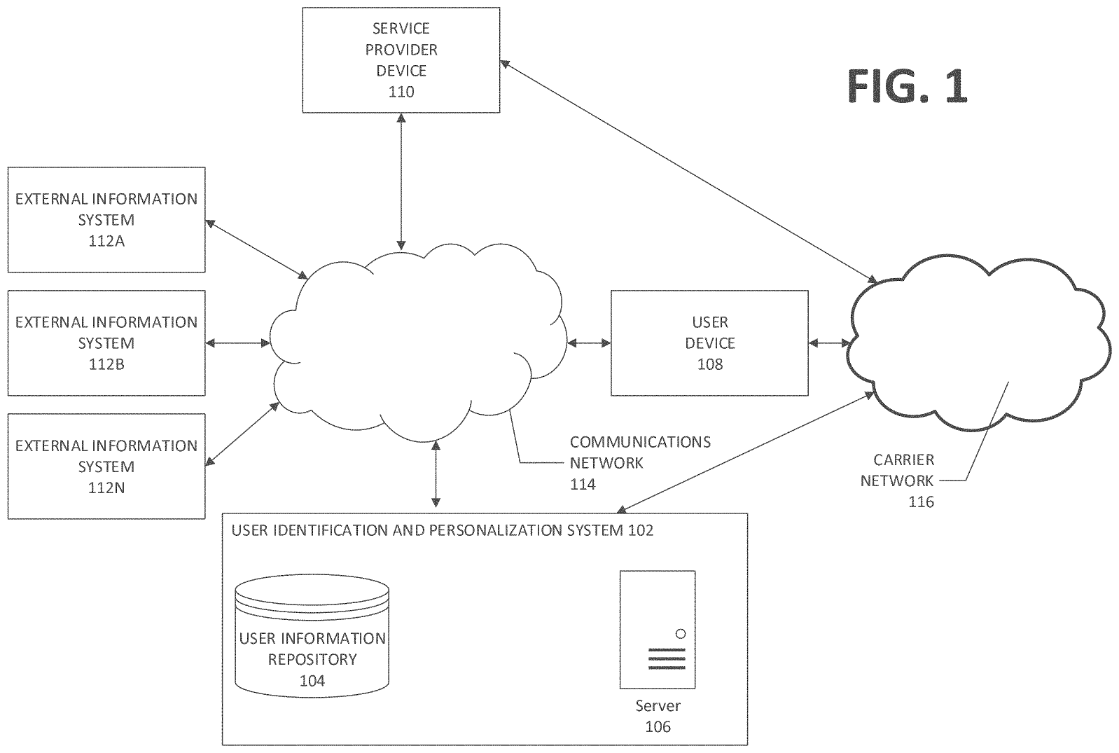

In this regard, FIG. 1 discloses an example computing system in which embodiments of the present invention may operate. FIG. 1 illustrates an overview for a system configured for using identity-linked information from a user device for improved user identification, to a service provider device, and transaction personalization, by a service provider device.

The system includes a user identification and personalization system 102, user device 108, service provider device 110, and external information systems 112A-112N (referred to as “external information systems 112”). The system is similarly associated with communications network 114 and carrier network 116, for communication between the various devices/sub-systems/components of the system. In other embodiments, the system may be associated with multiple user devices and/or service provider devices.

The user device 108 may be associated with any number of known computing devices. For example, the user device 108 may be embodied by a mobile phone, smart phone, tablet, laptop, personal computer, wearable device, set-top box, internet-of-things enabled device (IoT device), or the like. The user device 108 may include one or more components for capturing and analyzing, or in other words scanning, a decodable visual representation visible to the user device 108. The user device 108 may have additional modules embodied in hardware and/or software for decoding the scanned decodable visual representation. The user device 108 may be associated with a particular user entity that owns and/or controls the user device 108.

The user identification and personalization system 102 may be one or more computing apparatuses, devices, or the like, configured for using identity-linked device information for user identification and transaction personalization. As illustrated, the user identification and personalization system 102 includes at least server 104 and database 106. The server 104 may be in communication with the database 106.

The server 104 may be embodied as a computer or computers known in the art. The server 104 may provide for receiving identity-linked device information from the user device 108. For example, the server may be operable to receive the identity-linked device information from the user device 108 over the carrier network 116 via a header enrichment process. The carrier network 116 may include a carrier device (not shown) within the user identification and personalization system 102, or accessible to the user identification and personalization system 102. The carrier device may be configured to inject identity-linked device information into electronic data transmissions from the user device 108 to the user identification and personalization system 102.

The server 104 may further provide for retrieving user information from one or more external systems 112 based on the user-identity device information or a corresponding user identifier. For example, the server 104 may be operable to transmit an external information request to the external information systems 112 and receive, from each of the external information systems 112, user information in response. Each external information system 112 may be provided, in some embodiments, a user identifier determined based on the identity-linked device information to further preserve the security of the identity-linked device information.

The server 104 may further provide for transmitting, to the service provider device 110, user information and/or a user identifier for retrieving information. The server 104 may transmit information, such as a redirect link, to user device 108 to cause the user device 108 to forward the transmitted information to the service provider device 110. In other embodiments, the server 104 may transmit a user identifier or user information directly to the service provider device 110.

The server 104 may further provide for receiving requests from the service provider device 110 and providing corresponding information for purposes of user identification or transaction personalization. For example the server 104 may receive a user information query from the service provider device 110, and respond with user information. The server 104 may receive a verification request from the service provider device 110, and respond with a verification message confirming the identity of the user device 108.

The server 104 may further provide for determining identity-linked device information is associated with card information in an inactivated state, and activating the card information or communicating with the service provider device 110 to cause activation of the card information.

The server 104 may further provide for facilitating connections between a third-party device (not shown) associated with the service provider device 110, and the user device 108. The server 104 may be operable to begin a connection with the third-party device in response to a user device contact request from the service provider device 110 or associated third-party device (not shown).

The database 106 may be embodied as a data storage device such as one or more network attached storage (NAS) device(s), or as a separate database server or servers. The database 106 includes information accessed by, received by, and stored by the server 104 to facilitate the operations of the user identification and personalization system 102. For example, the database 106 may include identity-linked device information, corresponding user identifiers, and corresponding user information. The user information may be received and/or extracted by the user identification and personalization system, for example in facilitating previous user identification and/or transaction personalization associated with the service provider device 110, or retrieved from one or more external information systems such as the external information systems 110.

The database 106 may include one or more repositories, or one or more sub-repositories. For example, in some embodiments, the database 106 includes at least a user information repository for storing, managing, and retrieving user information. The database 106 may, additionally or alternatively, include an identity-linked device information repository for storing, managing, and retrieving identity-linked device information and/or associated user identifiers. It should be appreciated that the database 106 may comprise any number of sub-repositories, tables, and other configurations.

The service provider device 110 may be one or more computing devices operated by a third-party entity with respect to the user identification and personalization system 102, and configured to provide one or more services to users via connected user devices. For example, the service provider 110 may be one or more remote servers configured to provide particular information, a particular product, offering, service, software, or the like. A service provider device 110 may transaction with the user device 108 to receive a user identifier and/or user information, and provide a personalized webpage, session, information, or the like, based on the received user identifier and/or user information.

The service provider device 110 may manage one or more webpages, information, offerings, promotions, or the like associated with products, services, experiences, or the like. The service provider device 110 may receive user information from user identification and personalization system 102 (for example directly or indirectly through the user device 108), and utilize the information to provide personalized services to the user device 108. For example, the user information may be used to personalize a transaction interface provided to the user device 108 for rendering. For example, the service provider device 110 may provide a transaction confirmation interface to the user device 108, and may personalize the transaction confirmation interface by automatically filling out various inputs with default values based on the user information. In some embodiments, the service provider device 110 communicates with the user identification and personalization system 102 to receive confirmation or verification of a user's identity associated with the user device 102.

The user identification and personalization system 102 may communicate with the user device 108, the service provider device 110 and the external information systems over communications network 114. The user device 108 may communicate with the user identification and personalization system 102 and service provider device 110 over the carrier network 116. The carrier network 116 may be out-of-band with respect to communications network 114. The data channels and/or architecture for transmitting communications, requests, or other information via the carrier network 116 may be separate from that of communications network 114. The user device 108 may leverage both networks to prevent device-based and channel-based cyber-attacks, improving device and overall system security. In some embodiments, the communications network 114 and carrier network 116 may include one or more shared devices and/or components.

Alternatively or additionally, in some embodiments, the user device 108 may transmit some information via the carrier network 116 and other information via the communications network 114. The user device 108 may transmit/receive information over the carrier network 116 to/from various devices, and transmit/receive information over the communications network 114 to/from the same or other devices.

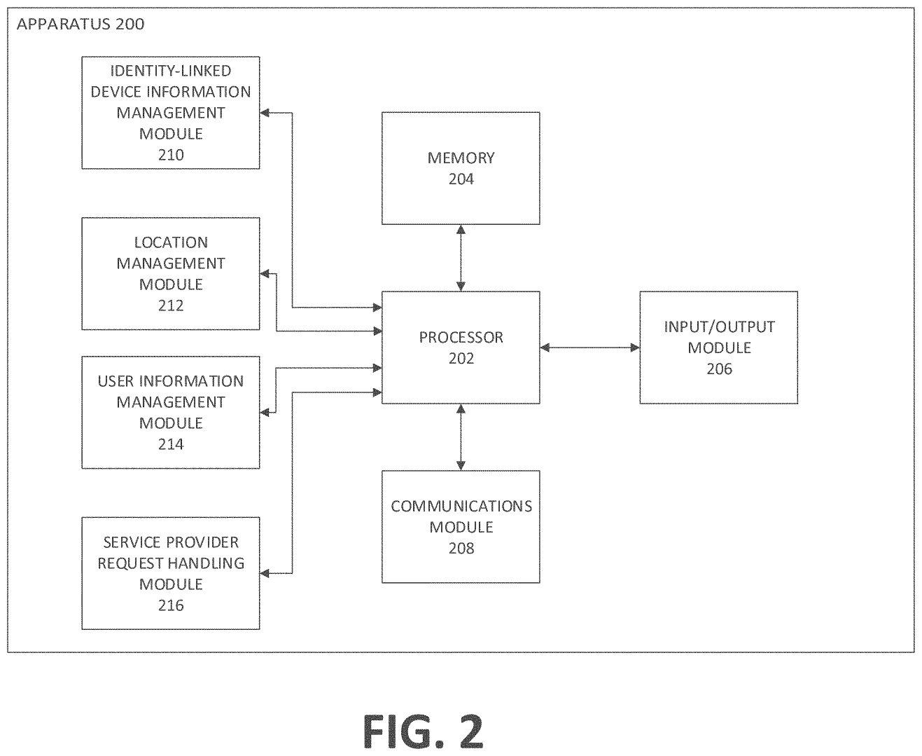

User identification and personalization system 102 may be embodied by one or more computing systems, devices, or apparatuses, such as the apparatus 200 shown in FIG. 2. As illustrated, the apparatus 200 may include a processor 202, a memory 204, an input/output module 206, a communications module 208, an identity-linked device information management module 210, a location management module 212, a user information management module 214, and a service provider request handling module 216. The apparatus 200 may be configured, using means such as the components 202-216, to perform the operations described herein. Although these components 202-216 are described with respect to functional limitations, it should be understood that a particular implementation necessarily includes the use of particular hardware. It should also be understood that certain of these components 202-216 may include similar or common hardware. For example, two modules/components/sets of components may both leverage use of the same processor, network interface, storage medium, and/or the like, to perform their associated functions, such that duplicate hardware is not required for each module. The use of the terms “module” and “circuitry” as used herein with respect to the components of the apparatus 200 should therefore be understood to include particular hardware configured to perform the functions associated with the particular component as described herein.

Indeed the terms “module” and “circuitry” should be understood broadly to include hardware and, in some embodiments, software and/or firmware for configuring the hardware. For example, in some embodiments, the term “module” may include processing circuitry, storage medium(s), network interface(s), input/output device(s), and the like. In some embodiments, some modules of the apparatus 200 may provide or supplement the functionality of another particular module or multiple modules. For example, the processor 202 may provide processing functionality, the memory 204 may provide storage functionality, the communications module 208 may provide network interface functionality, and the like.

In some embodiments, the processor 202 (and/or co-processor and any other processing module assisting or otherwise associated with the processor) may be in communications with the memory 204 via a bus for passing information among components of the apparatus 200. The memory 204 may be non-transitory and include, for example, one or more volatile and/or non-volatile memories. In other words, for example, the memory may be an electronic storage device (e.g., a computer readable storage medium). The memory 204 may be configured to store information, data, content, applications, instructions, or the like, for enabling the apparatus to carry out various functions in accordance with example embodiments of the present disclosure.

The processor 202 may be enabled in a number of different ways and may, for example, include one or more processing devices configured to perform independently. Additionally or alternatively, the processor may include one or more processors configured in tandem with a bus to enable independent execution of instructions, pipelining, and/or multi-threading. The use of the terms “processor”, “processing module”, and “processing circuitry” may be understood to include a single core processor, a multi-core processor, multiple processors internal to the apparatus, and/or remote or “cloud” processors.

In an example embodiment, the processor 202 may be configured to execute instructions stored in the memory 204 or otherwise accessible to the processor. Alternatively or additionally, the processor may be configured to execute hard-coded functionality. As such, whether configured by hardware methods, software methods, or a combination thereof, the processor may represent an entity (e.g., physically embodied in the circuitry) capable of performing operations according to an embodiment of the present invention while configured accordingly. Alternatively, as another example, when the processor is embodied as an executor of software instructions, the instructions may specifically configure the processor to perform the algorithms and/or operations described herein when the instructions are executed.

In some embodiments, the apparatus 200 may include input/output module 206 that may, in turn, be in communication with processor 202 to provide output to the user and, in some embodiments, to receive an indication of a user input. The input/output module 206 may comprise a user interface and may include a display and may comprise a web interface, a mobile application, and/or another user interface, or the like. In some embodiments, the input/output module 206 may also include a keyboard, a mouse, a touch screen, touch areas, soft keys, a microphone, a speaker, or other input/output mechanisms. The processor and/or user interface module comprising the processor may be configured to control one or more functions of one or more user interface elements through computer program instructions (e.g., software and/or firmware) stored on a memory accessible to the processor, such as memory 204 and/or the like.

The communications module 208 may be any means, such as a device, module, and/or circuitry embodied in either hardware or a combination of hardware and software, that is configured to receive and/or transmit data from and/or to another device, module, circuitry, or the like in combination with the apparatus 200. The communications module 208 may include means to communicate with remote devices (such as the user device 108, service provider device 110, and/or external information systems 112) via one or more networks. In this regard, the communications module 208 may include, for example, one or more network interfaces for enabling communications with one or more wired or wireless communication networks. For example, the communications module 208 may include one or more network interface cards, antennae, buses, switches, routers, modems, and supporting hardware and/or software, or any other device suitable for enabling communications via a network. Additionally or alternatively, the communications module may include a communications interface including circuitry for interacting with the antenna(s) to cause transmission of signals via the antenna(s) or to handle receipt of signals via the antenna(s).

The identity-linked device information management module 210 includes hardware, software, or a combination thereof, for receiving identity-linked device information, storing/managing identity-linked device information and/or one or more corresponding user identifier. The identity-linked device information management module 210 may be configured to generate one or more user identifier(s) associated with identity-linked device information. In some embodiments, the identity-linked device information management module 210 is configured to communicate with one or more databases and/or sub-repositories therein for storing identity-linked device information or corresponding user identifier(s), for example in an identity-linked device information repository. The identity-linked device information management module 210 may be configured to communicate with one or more other modules of the apparatus 200 to perform one or more of these functions. For example, the identity-linked device information management module 210 may receive the identity-linked device information utilizing, for example, at least the processor 202 and/or communications module 208. In some embodiments, the identity-linked device information management module 210 may include a separate processor, specially configured field programmable gate array (FPGA), or application specific interface circuit (ASIC). The identity-linked device information management module 210 is configured for implementing at least these planned functions, and in some embodiments may perform one or more additional and/or alternative functions, as well as part operations or whole operations described with respect to the other modules as illustrated.

The location management module 212 includes hardware, software, or a combination thereof, for determining a location associated with a user device, and/or whether the location is within a threshold distance of a second identified location. In some embodiments, the location management module 212 may be configured to retrieve a request-related device location associated with a user device, identify a decodable location associated with a decodable visual representation, determine whether the request-related device location is within a threshold distance from the decodable location, and identify user information based on the determination. The request-related device location may be determined via location services of the user device, triangulation using various towers, or by determining a retrieving a known device indication indicative of whether the user device is communicable with a known device (e.g., a Wi-Fi, Bluetooth, or Internet-of-Things device), and determine whether the known device indication indicates the user device is communicable with the known device. Additionally or alternatively, the location management module 212 may be configured to cause the user device to generate a confirmation identifier, retrieve a request-related device location associated with the user device, receive the confirmation identifier from the service provider device, identify a mailed location via a real-time postal service application programming interface, and determine whether the mailed location is within a threshold distance from the request-related device location, and identify user information indicative of whether the authentication was successful when the mailed location is within the threshold distance. In some embodiments, the location management module 212 is configured to perform one or more alternative or additional authentication processes/sub-processes for minimizing the likelihood that the identity-linked device information was transmitted by a fraudulent user device. For example, the location management module 212 may determine whether a request-related device location associated with the user device, and may terminate a user identification and/or personalization process if the location is outside a threshold distance from a decodable location.

The location management module 212 may be configured to communicate with one or more other modules of the apparatus 200 to perform one or more of these functions. For example, the location management module 212 may receive one or more request-related device locations associated with a user device, or identify a mailed location via a real-time postal service application programming interface, for example, utilizing at least the processor 202 and/or communications module 208. In some embodiments, the location management module 212 may include a separate processor, specially configured field programmable gate array (FPGA), or application specific interface circuit (ASIC). The location management module 212 is configured for implementing at least these planned functions, and in some embodiments may perform additional and/or alterative functions, as well as part operations or whole operations described with respect to the other modules as illustrated.

The user-information management module 214 includes hardware, software, or a combination thereof, for generating, extracting, identifying, retrieving, and/or storing/managing user information associated with identity-linked device information or a user identifier. In some embodiments, user information management module 214 is configured to extract or otherwise identify user information from one or more transmissions received from a user device and/or service provider device. For example, user information may be received as part of an electronic data transmission received by the user device along with identity-linked device information, or as part of one or more queries received from a service provider device.

Additionally or alternatively, the user information management module 214 may be configured to transmit one or more external information requests to one or more external information systems, and receive sets of user information in response to each of the external information requests. In some embodiments, the user information management module 214 may transmit an external information request to multiple external information systems, and generate user information for providing to a service provider device using various sets of user information received from each of the external information systems in response.

In some embodiments, the user information management module 214 may retrieve previously stored user information for transmitting to a service provider device. For example, in some embodiments the user information management module 214 is configured to read from the user information repository to retrieve stored user information. Additionally or alternatively, the user-information management module 214 may be configured to write to the user information repository to store user information, such as information newly received from a user device, service provider device, or one or more external information systems.

The user information management module 214 may be configured to communicate with one or more other modules of the apparatus 200 to perform one or more of these functions. For example, the user information management module 214 may receive the user information from one or more remote devices utilizing, for example, at least the processor 202 and/or communications module 208. Additionally or alternatively, the user information management module 214 may store/retrieve stored user information utilizing, for example, at least the processor 202 and/or memory 204. In some embodiments, the user information management module 214 may include a separate processor, specially configured field programmable gate array (FPGA), or application specific interface circuit (ASIC). The user information management module 214 is configured for implementing at least these planned functions, and in some embodiments may perform additional and/or alterative functions, as well as part operations or whole operations described with respect to the other modules as illustrated.

The service provider request handling module 216 includes hardware, software, or a combination thereof, for receiving one or more requests from a service provider device for performing one or more user identification and/or transaction personalization actions associated with identity-linked device information and/or a corresponding user identifier. In some embodiments, the service provider request handling module 216 includes means configured transmit user information to a service provider device. Additionally or alternatively, in some embodiments, the service provider request handling module 216 is configured to generate and/or transmit a verification message to a service provider device indicating the user identity associated with the user device (e.g., based on the identity-linked device information) is further associated with the service provider device. Additionally or alternatively, in some embodiments, the service provider request handling module 216 is configured to cause the service provider device to activate card information associated with a debit/credit card having card information in an inactivated state. Additionally or alternatively, in some embodiments, the service provider request handling module 216 is configured to connect a third-party device associated with the service provider device to the user device, without exposing the identity-linked device information or other PII associated with the user device. To perform one or more of the above operations, the service provider request handling module 216 may be configured to receive various requests from, and transmit various responses to, a service provider device.

The service provider request handling module 216 may be configured to communicate with one or more other modules of the apparatus 200 to perform one or more of these functions. For example, the service provider request handling module 216 may receive one or more requests of various types from a service provider device utilizing, for example, at least the processor 202 and/or communications module 208. Additionally or alternatively, the service provider request handling module 216 may transmit one or more responses of various types to a service provider device utilizing, for example, at least the processor 202 and/or communication module 208. In some embodiments, the service provider request handling module 216 may include a separate processor, specially configured field programmable gate array (FPGA), or application specific interface circuit (ASIC). The service provider request handling module 216 is configured for implementing at least these planned functions, and in some embodiments may perform additional and/or alterative functions, as well as part operations or whole operations described with respect to the other modules as illustrated.

It should be appreciated that one or more of the modules 202-216 may be combined to form one module that performs the function of multiple modules. In some embodiments, for example, each of the modules 210-216 may be embodied entirely in one or several software modules for execution in conjunction with the processor 202 and memory 204.

As will be appreciated, any such computer program instructions and/or other type of code may be loaded onto a computer, processor, or other programmable apparatus' circuitry to produce a machine, such that the computer, processor, or other programmable circuitry that executes the code on the machine creates the means for implementing various functions, including those described herein. For example, in some embodiments, one or more of the modules may be entirely embodied by one or more software modules for performing the functions identified.

As described above and as will be appreciated based on the disclosure, embodiments of the present disclosure may be configured as methods, mobile devices, backend network devices, and the like. Accordingly, embodiments may comprise various means including entirely hardware, or a combination of hardware and software. Further, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, flash memory, CD-ROMs, optical storage devices, magnetic storage devices, or the like.

### Example Data Flow

Having thus described the system, an example data flow will now be described. It should be appreciated that the described data flows, operations, processes, and the like are non-limiting examples, and the system may perform various data flows in a myriad of ways using various system configurations.

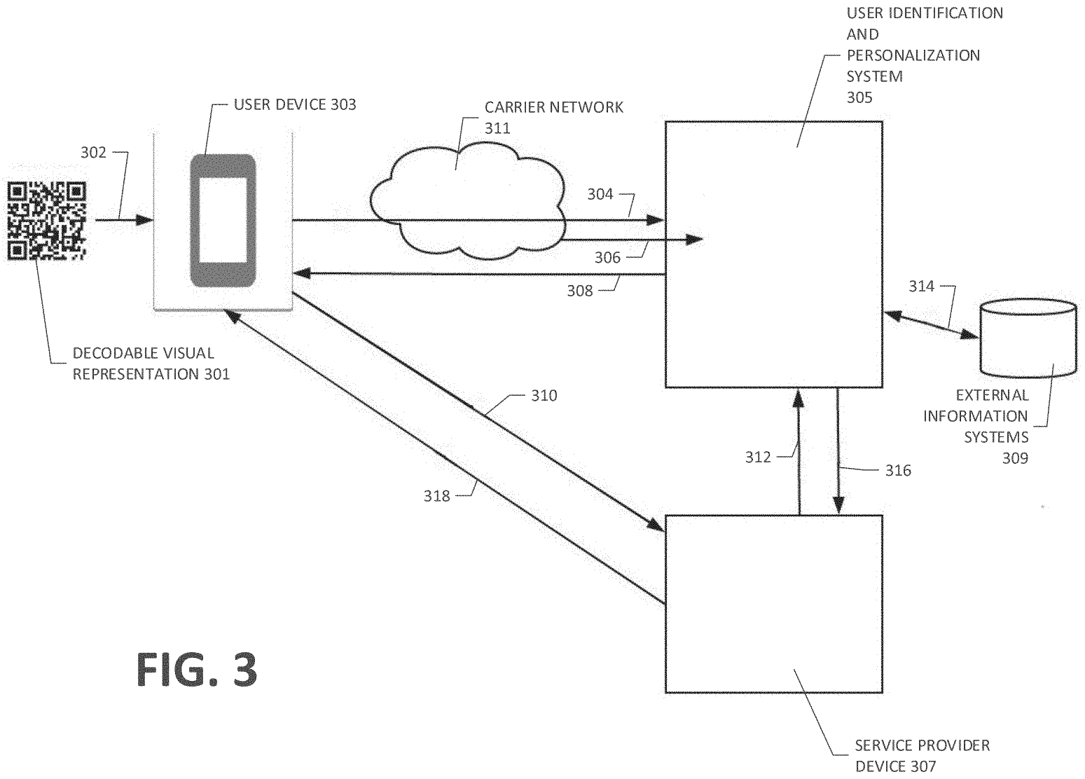

FIG. 3 illustrates a data flow diagram depicting operations for user identification and/or transaction personalization via a user identification and personalization system. Specifically, FIG. 3 illustrates a data flow diagram for a specific embodiment including a specific system including user device 303, user identification and personalization system 305, service provider device 307, and external information systems 309.

At step 302, user device 303 scans to decode a decodable visual representation 301. The decodable visual representation 301 may be embodied in a variety of ways, including a QR code, one-dimensional barcode, data matrix, and the like. The decodable visual representation 301 may be printed, rendered to, or otherwise displayed on any type of medium. For example, the decodable visual representation 301 may be printed on marketing materials, mailings, billboards, walls, vehicles, or otherwise physically presented. Alternatively, the decodable visual representation 301 may be rendered to a screen, such as a mobile phone screen, television screen, monitor, or otherwise digitally presented.

The user device 303 may scan the decodable visual representation 301 using various means built into, integrated with, or otherwise associated with the user device 303. For example, user device 303 may be associated with one or more cameras, and/or corresponding software and/or firmware, for capturing the decodable visual representation 301. The hardware, software, and/or firmware may further be configured to decode the decodable visual representation 301 to decoded information. The decoded information may include at least a URI (or URL) accessing the service provider device 307 via the user identification and personalization system 305. Additionally or alternatively, the decoded information may include at least a source identifier associated with the targeted user entity and decodable visual representation (e.g., an address where a mailing with the decodable visual representation 301 was mailed, and/or additional information such as a name, address, phone number, or the like).

In some embodiments, in response to decoding the URI, the user device 303 may generate and render an access link associated with the URI to a display associated with the user device 303. The rendered access link may be executed in response to user engagement, for example a click, tap, voice command, or the like. In other embodiments, the user device 303 may generate and/or automatically execute an access link associated with the URI. For example, the user device 303 may automatically execute an access link associated with the URI via a browser application executed on the user device 303.

At step 304, the user device 303 transmits an electronic data transmission to the user identification and personalization 305 in response to execution of an access link. The electronic data transmission is transmitted from the user device 303 over the carrier network 311, which may include one or more connected carrier devices. The electronic data transmission is indicative of the prior execution of the access link having been detected and decoded from the decodable visual representation 301, and having caused the user device to execute the access link (either automatically or in response to user engagement with the access link). The electronic data transmission may include a source identifier and/or other decoded information scanned and decoded from the decodable visual representation 301.

At step 306, a carrier device within the carrier network injects identity-linked device information associated with the user device 303 into the electronic data transmission using a header enrichment process. In some embodiments, the access link is configured to indicate that a header enrichment process should be performed. For example, the URI associated with the access link may be a specific, white-listed URI (or URL) to trigger the header enrichment process by a carrier device within the carrier network 311. The carrier device performing header enrichment may be an endpoint device included as part of the user identification and personalization system 305. Alternatively, the carrier device may perform the header enrichment process, then forward the electronic data transmission with injected identity-linked device information to the user identification and personalization system 305. Thus, the user identification and personalization system 305 receives the electronic data transmission, including the identity-linked device information, from the user device 303. The electronic data transmission may be received from the user device directly, or from the user device indirectly through forwarding by a carrier device.

IN some embodiments, the decodable visual representation 301 may contain a URL pre-defined within a subdomain (or other range) such that the URI is preselected to terminate at a particular carrier device. For example, the URI may be predefined to (1) trigger packet header enrichment (or another secure process) upon termination at the carrier device, and (2) include identifying information, such as a source identifier, that points to a database record accessible to the carrier device and/or user identification and personalization system, where the database record includes user information, that contains, for example, a name, address, city, state, zip code, and the like associated with the user entity. The URI may be embedded as part of the decodable visual representation 301. The carrier device may be triggered to perform the header enrichment process in response to the termination of the electronic data transmission at the carrier device.

The header enrichment process may inject determined identity-linked device information into the packet header of the electronic data transmission for receiving by the server hosting the URI associated with the access link. For example, the identity-linked device information may be injected into the HTTP or HTTPS header. In some embodiments, for example, the identity-linked device information is a mobile phone number associated with the user device 303. In such embodiments, the mobile phone number may be accessed via a SIM using a highly secure process (usually used for billing customers). The mobile phone number may be in any format, for example plaintext or hashed. In other embodiments, the identity-linked device information may include other mobile device account information associated with the user device 303, which may be retrieved using the same highly secure process associated with a SIM.

At step 308, the user identification and personalization system 305 transmits a user identifier associated with the received identity-linked device information. The user identification and personalization system 305 may have generated and/or retrieved the user identifier based on the received identity-linked device information. The user identifier is utilized as a key for retrieving user information associated with the user device 303 and corresponding user entity controlling the user device 303.

At step 310, the user device 303 forwards the user identifier to the service provider device 307. In some embodiments, at step 308, the user identifier is received by the user device 303 as part of a redirect link configured to cause the user device 303 to automatically cause the user device to forward the user identifier to the service provider device 307. In other embodiments, the step 310 may be performed in response to user engagement with a confirmation or other user interface component rendered by the user device 303 in response to receiving the user identifier at step 308.

In some embodiments, upon receiving the user identifier at step 310, the service provider device 307 may utilize the user identifier to retrieve user information from a repository controlled by service provider device 307. For example, the user identifier may operate as a key for retrieving various user information the repository. The service provider device may then utilize the retrieved user information to provide personalized services to the user device 303. For example, the service provider device 307, without contacting the user identification and personalization system, may immediately provide a personalized response to the user device 303 based on the retrieved user information associated with the user identifier.

Additionally or alternatively, upon receiving the user identifier, the service provider device 307 may utilize the user identifier for performing various user identification and/or transaction personalization actions via the user identification and personalization system 305. For example, the service provider device 307 may communicate with the user identification and personalization system 305 to receive user information for personalizing transactions/services to the user device 303. Additionally or alternatively, the service provider device 307 may communicate with the user identification and personalization system 305 to activate a new credit/debit card associated with the user identifier. Additionally or alternatively, the service provider device 307 may communicate with the user identification and personalization system 305 for receiving a verification message, for example for personalized two- or multi-factor authentication purposes. Additionally or alternatively, the service provider device 307 may retrieve a system contact number from the user identification and personalization system 305 for connecting a third-party device associated with the service provider device 305 to the user device 303 via the user identification and personalization system 305.

Specifically, in some embodiments, the service provider device 307 may query the user identification and personalization system 305 for user information associated with the user identifier. At step 312, the service provider device 307 transmits a user information query to the user identification and personalization system 305. The user information query may include at least the user identifier received from the user device 303.

The user identification and personalization system 305 may retrieve user information. In some embodiments, at step 314, the user identification and personalization system 305 transmits an external information request to one or more external information systems 309. The external information systems may include one or more third-party systems associated with various third-party entities. For example, the external information systems may include a credit reporting device associated with a credit reporting entity, an advertising aggregation device or repository associated with an advertising aggregation entity, or other devices including customer-specific information, demographic information, psychographic information, and/or behavioral information. The user identification and personalization system 305 may communicate with each of the external information systems 309 using one or more APIs. Information may be received from external information systems 309 using the user identifier, the corresponding identity-linked device information, or a combination thereof.

At step 316, the user identification and personalization system 305 transmits user information to the service provider device 307 in response to the earlier received user information query. In some embodiments, the user identification and personalization system 305 is configured to combine multiple user information subsets to generate or otherwise create the user information for transmittal to the service provider device 307, where the user information subsets may be retrieved from the service provider device 307, the user identification and personalization system 305, one or more of the external information systems 309, or a combination thereof. For example, in some embodiments, the user identification and personalization system 305 may store no user information, and thus may retrieve user information subsets only from the service provider device 307 and/or one or more external information systems 309. In other embodiments, the user identification and personalization system may only retrieve external user information retrieved from one or more of the external information systems 309, and return some (or all) of the external user information as user information provided to the service provider device 307.

After receiving the user information at step 316, the service provider device 307 may utilize the received user information to provide a personalized experience to the user device 303. At step 318, the service provider device 307 transmits the personalized information to the user device 303. In some embodiments, the personalized information includes personalized interface information for rendering via the user device 303 (e.g., via a browser application executed on the user device 303 or a local application, for example).

In some embodiments, the personalized interface information may be personalized to include pre-populated information inputs based on the user input. For example, the personalized interface may be utilized to pre-populate most, if not all, information necessary to execute a transaction. For example, in some embodiments, the personalized interface may include a delivery location, delivery method, payment type, item preference selections (e.g., color, size, and the like), or item for purchase, based on historical ordering data associated with the user entity. In some embodiments, the user information may be combined with some or all of the decoded information received and forwarded in response to decoding the decodable visual representation 301. For example, the decoded information may be forwarded to the service provider device 307, and include an item identifier associated with an item for purchase, a quantity value, a price value, and/or similar transaction details. In some embodiments, the user information may override one or more values received as part of the decoded information. For example, the user information may indicate that the price value for the transaction is lowered because the customer is a returning customer, or has otherwise received a promotion or discount.

The personalized interface information may be transmitted to the user device 303 for rendering. After step 318, the user device 303 may render a personalized interface associated with the personalized interface information. For example, in some embodiments, the personalized interface may include various interface inputs/components pre-populated based on the user information. In some embodiments, the personalized interface may correspond to a prospective transaction to purchase a product, service, item, experience, or the like. The personalized interface may include various interface inputs pre-populated based on the user information and/or decoded information such that the transaction may be submitted with the authorization by the user entity, for example with a single tap of a confirmation button.

In some embodiments, the system and/or operational data flow differs from that illustrated in FIG. 3. For example, in some embodiments, the service provider device 307 retrieves user information without contacting the user identification and personalization system 305, and thus steps 312-316 are not performed. In other embodiments, different personalization services may be performed by the service provider device 307 via the user identification and personalization system 305. The specific system and operational steps illustrated in FIG. 3 are non-limiting, and not to limit the spirit and scope of the disclosure herein.

### Example Operations for Applications of the User

### Identification and Transaction Personalization System

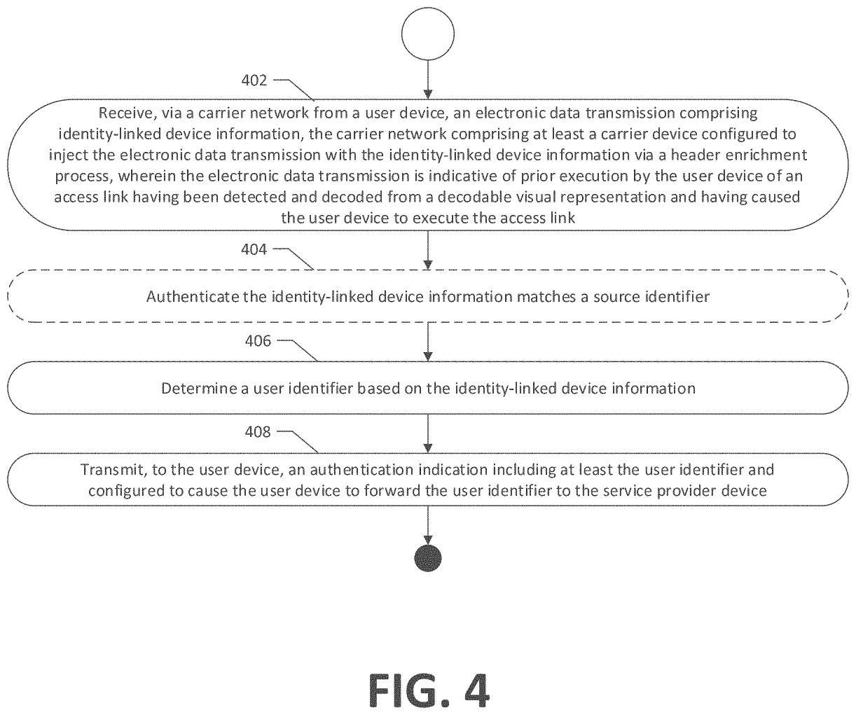

FIG. 4 illustrates an example process for authenticating a user identity associated with a user entity for a user device, and using identity-linked device information to enable user identification and transaction personalization in response to mobile tagging, for example performed by a user identification and personalization system embodied by apparatus 200. The operations illustrated may be, in some embodiments, performed after a user device (such as a mobile device) scanned a decodable visual representation and executed a corresponding access link.

At block 402, the apparatus 200 includes means, such as identity-linked device information management module 210, communications module 208, processor 202, and/or the like, or a combination thereof, to receive, via a carrier network, an electronic data transmission including at least identify-linked device information, the carrier network including at least a carrier device configured to inject the electronic data transmission with the identify-linked device information via a header enrichment process, where the electronic data transmission is indicative of prior execution by the user device of an access link having been detected and decoded from a decodable visual representation and having caused the user device to execute the access link.

In some embodiments, the identity-linked device information is a mobile phone number. The mobile phone number may be in a hashed format or a plaintext format. The mobile phone number may be trusted due to the trustworthiness of the carrier network and the header enrichment process, which relies on the high security associated with retrieving the mobile phone number via the SIM. Thus, by receiving the mobile phone number associated with the user device, the user identification and personalization system can be sure that the mobile phone number is associated with the user device that transmitted the electronic data transmission.

In some embodiments, the electronic data transmission includes information additional to the identity-linked device information. For example, in some embodiments, the electronic data transmission additionally includes at least a source identifier decoded from the decodable visual representation. The source identifier may uniquely identifies information regarding the decodable visual representation and/or targeted individual user entity. For example, the source identifier may uniquely identify the address to which a mailing including the decodable visual representation was sent for a targeted user entity. The source identifier may be encoded by the decodable visual representation such that the user identification and personalization system may determine the location associated with the scanned decodable visual representation without encoding personally identifying information. In other embodiments, where the decodable visual representation is not provided via a mailing for example, the source identifier may uniquely identify an address or location (e.g., GPS position, latitude and longitude, or the like) that the decodable visual representation is associated with/posted.

The carrier device configured to perform the header enrichment process may, in some embodiments, be a sub-component of, or otherwise associated with the user identification and personalization system. In such embodiments, the user identification and personalization system may receive the electronic data transmission from the user device directly, without forwarding from the carrier device. In other embodiments, the carrier device is separate from the user identification and personalization system. In such embodiments, the carrier device configured to perform the header enrichment process may inject the identity-linked device information into the electronic data transmission and forward the electronic data transmission (including the injected identity-linked device information) to the user identification and personalization. In such embodiments, the user identification and personalization system may receive the electronic data transmission indirectly from the user device.

At optional block 404, the apparatus 200 includes means, such as location management module 212, processor 202, and/or the like, or a combination thereof, to authenticate the identity-linked device information matches a source identifier. In some embodiments, the source identifier is included in the electronic data transmission received from the user device. In some embodiments, the apparatus 200 may retrieve expected information associated with the source identifier, and the identity-linked device information may be considered to match if the expected information matches the received identity-linked device information. The source identifier may be matched to confirm the targeted user entity scanned the decodable visual representation as opposed to an untargeted user entity. In other embodiments, the source identifier may include expected information (e.g., an expected phone number) for matching to the received identity-linked device information.

The source identifier may be used to access various user information. For example, the source identifier may be used to access a mailed-to address, past customer information (including preferences, billing information, and the like), or other user information.

At block 406, the apparatus includes means, such as identity-linked device information management module 210, processor 202, and/or the like, or a combination thereof, to determine a user identifier based on the identity-linked device information. In some embodiments, the user identifier is the source identifier. In other embodiments, the user identifier may be stored by the user identification and personalization system. In some embodiments, the user identifier may be generated by the user identification and personalization system.

At block 408, the apparatus includes means, such as user information management module 214, communications module 208, processor 202, and/or the like, or a combination thereof, to transmit, to the user device, an authentication indication including the user identifier and configured to cause the user device to forward the user identifier to the service provider device. In some embodiments, the authentication indication includes is embodied by a redirect link including various parameters, including the user identifier. The redirect link may cause the user device to automatically access the service provider device, for example via a browser application, and forward the user identifier. In other embodiments, the authentication indication causes the user device to prompt the user entity to access the service provider device, for example via a confirmation message. The user device may access the service provider device in response to user engagement by the user entity associated with the user device indicating approval to access the service provider device.

The user identifier enables the service provider device to retrieve user information associated with the user identifier for use in providing personalized information and/or interfaces to the user device. In some embodiments, the service provider device retrieves user information associated with the user identifier from a repository managed by, or otherwise accessible to, the service provider device without accessing the user identification and personalization system.

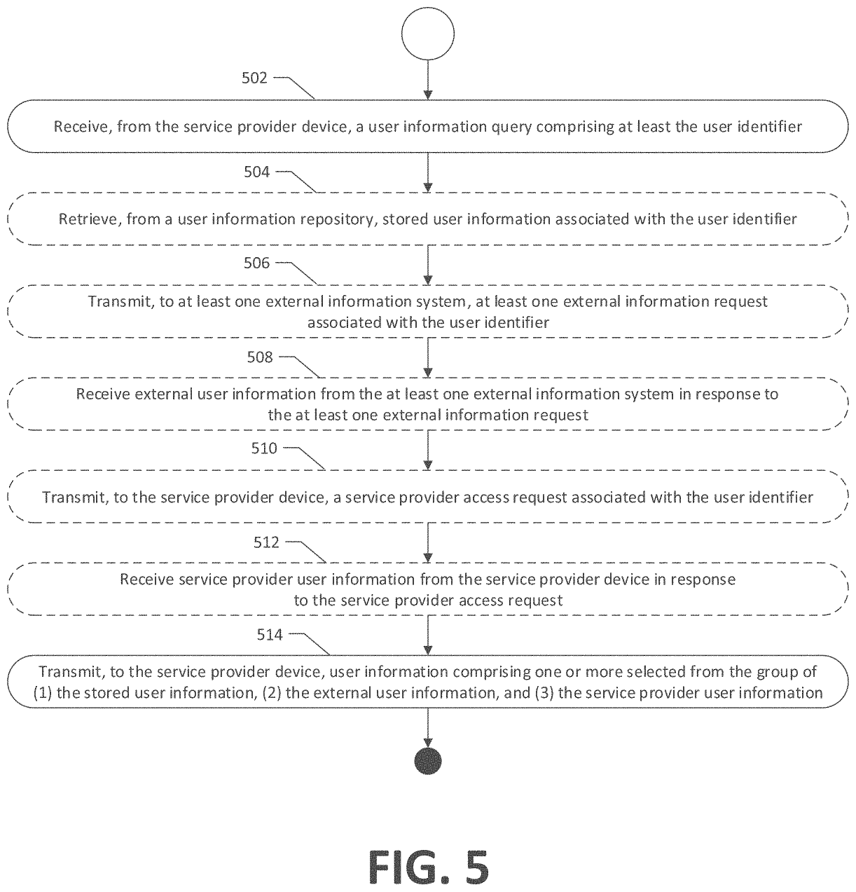

In other embodiments, the service provider device provides personalized information and/or interfaces to the user device based on user information received from the user identification and personalization system, for example via the process illustrated in FIG. 5. FIG. 5 illustrates an example process for retrieving user information for use in providing transaction/experience personalization, for example performed by a user identification and personalization system embodied by apparatus 200. The operations illustrated may, in some embodiments, be performed after the service provider device has received a user identifier. For example, some or all of the operations illustrated with respect to FIG. 5 may be performed after the process illustrated in FIG. 4.

At block 502, the apparatus 200 includes means, such as service provider request handling module 216, communications module 208, processor 202, and/or the like, or a combination thereof, to receive, from the service provider device, a user information query comprising at least the user identifier. The user information query may include an identifier associated with a particular application the user information is to be used for. For example, the user information query may include an identifier indicating the user information is to be used to personalize a transaction. The user information query may include a different identifier indicating the user information is to be used to authenticate a user identity associated with the user device, for example as two- or multi-factor authentication. The identifier associated with the particular application for the user information may be utilized to limit the retrieved user information from the various sources, as discussed below with respect to blocks 504-512.

At optional block 504, the apparatus 200 includes means, such as user information management module 214, communications module 208, processor 202, and/or the like, or a combination thereof, to retrieve, from a user information repository, stored user information associated with the user identifier. The apparatus 200 may be configured to manage the user information repository (e.g., via hardware and/or software). The user information repository may be configured by the apparatus 200 to store decoded information, a source identifier, and the like, encoded by or associated with scanned decodable visual representations.

Additionally or alternatively, the user information repository may be configured to store user information previously retrieved associated with prior user information queries received from the service provider device. For example, the user information repository may include previously received service provider user information, previous received external user information, or other information previously received by the apparatus. For example, the user information repository may store previous payment method information, shipping/delivery information, or the like, associated with a prior transaction with the service provider device or with a different service provider device. The stored previous payment method information and/or shipping/delivery information may be retrieved for use in subsequent transaction personalization, even if the service provider entity associated with the service provider device associated with the prior transaction is different from the current service provider device. In other words, user information collected may be used to personalize transactions associated with various service provider devices for various service provider entities (e.g., a user payment method used to pay for a restaurant order last week may be stored and used to provide a personalized option to the user entity to use the user payment method again for a new transaction associated with a different restaurant). The apparatus 200 may retrieve the stored user information by querying the user information repository for user information associated with the user identifier and/or identity-linked device information, and receiving result data including the stored user information.

At optional block 506, the apparatus 200 includes means, such as user information management module 214, communication module 208, processor 202, and/or the like, or a combination thereof, to transmit, to at least one external information system, at least one external information request associated with the user identifier. An external information system may be associated with various entity types. For example, in some embodiments, an example external information system may be a carrier system associated with the mobile carrier for the user device. Another external information system may be a credit reporting system associated with a credit reporting agency. Another external information system may be an advertising aggregation system (or database) associated with an advertising aggregation entity.

The apparatus may communicate with any number of external information systems. For example, in some embodiments, the apparatus may not be configured to communicate with any external information systems. In other embodiments, the apparatus may be configured to communicate with one external information system. In other embodiments, the apparatus may be configured to communicate with two or more external information systems. The apparatus may communicate with one or more external information systems using one or more APIs.

At optional block 508, the apparatus 200 includes means, such as user information management module 214, communications module 208, processor 202, and/or the like, or a combination thereof, to receive external user information from the at least one external information system in response to the at least one external information request. In some embodiments, the external user information is received from a single external information system, or is a portion of received information received from a single external information system. In some embodiments where the apparatus communicates with two or more external information systems, the apparatus may combine received subsets of external user information (e.g., different subsets of external user information from different external information systems), or portions thereof, to form the external user information.

The external user information may include various different information based on the external information system from which it was received. For example, external user information retrieved from a carrier system may include name, address, and/or customer-specific account information. External user information retrieved from a credit reporting system and/or advertising aggregation system/database may include customer-specific, demographic, psychographic, and/or behavioral information. In some embodiments, the external information systems communicated with may be limited based on the desired type of external user information (e.g., which may be determined based on the user information query, such as an identifier associated with the particular application the user information is to be used for).

At optional block 510, the apparatus 200 includes means, such as user information management module 214, communications module 208, processor 202, and/or the like, or a combination thereof, to transmit, to the service provider device, a service provider access request associated with the user identifier. In some embodiments, apparatus may communicate with the service provider device using one or more APIs.

At optional block 512, the apparatus 200 includes means, such as user information management module 214, communications module 208, processor 202, and/or the like, or a combination thereof, to receive service provider user information from the service provider device in response to the service provider access request. In some embodiments, the service user information may include historical transaction information and/or preference information associated with the user identifier.

In some embodiments, the user information query received at block 502 may include service provider user information from the service provider device. In such embodiments, the apparatus 200 may include the service provider user information, or a subset thereof, in the user information later provided to the service provider device without requesting and receiving such information via blocks 510 and 512.

At block 514, the apparatus 200 includes means, such as service provider request handling module 216, communications module 208, processor 202, and/or the like, or a combination thereof, to transmit, to the service provider device, user information including one or more selected from the group of (1) the stored user information, (2) the external user information, and (3) the service provider user information. In some embodiments, the user information transmitted to the service provider device may include a portion of the stored user information, a portion of the external user information, and/or a portion of the service provider user information. In some embodiments, the user information includes additional information derived from the various user information retrieved from various sources (e.g., the stored user information, the external user information, and the service provider user information). For example, the user information may include a price value for a personalized transaction, based on a portion of the various user information retrieved from various sources (e.g., whether the user is a returning customer or meets promotion/discount requirements). Additionally or alternatively, the user information may include a delivery location, payment method information, item amount, and the like, derived from the various user information retrieved from various sources.

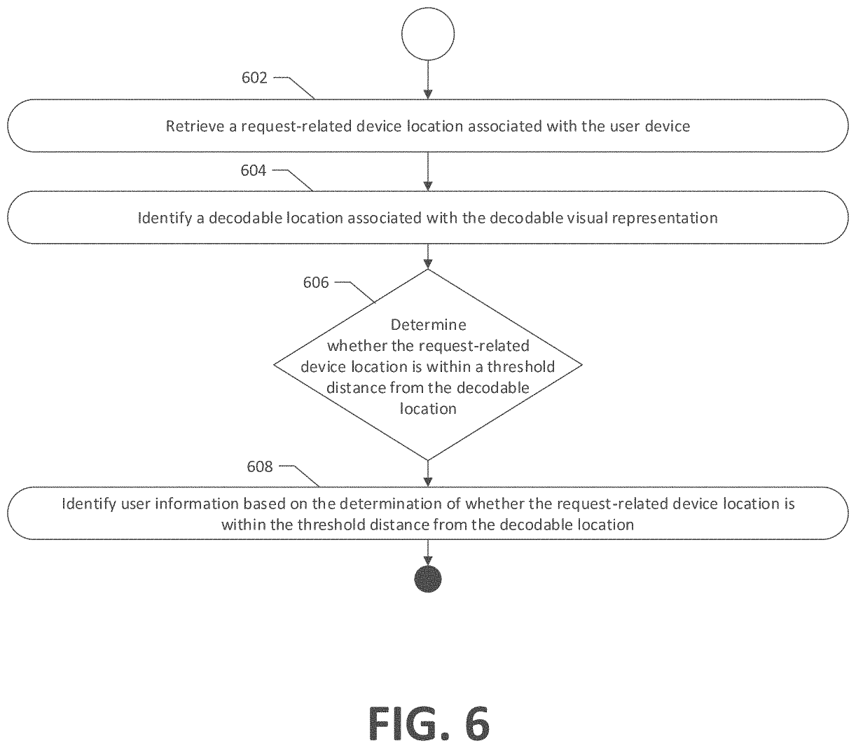

The user information provided by the user identification and personalization system to the service provider device may depend on the application for which the user information is to be used. For example, the user identification and personalization system may be configured to perform various operations to determine appropriate user information appropriate for enabling the service provider device to perform a particular application. In this regard, for example, FIGS. 6-10 illustrate example operations for determining appropriate user information for different applications.

FIG. 6 illustrates an example process for identifying appropriate user information for personalization based on a request-related device location and a decodable location, for example performed by a user identification and personalization system embodied by apparatus 200. The operations illustrated may, in some embodiments, be performed after the service provider device has received a user identifier and transmitted a user information query to the user identification and personalization system embodied by the apparatus 200.

At block 602, the apparatus 200 includes means, such as location management module 212, communications module 208, processor 202, and/or the like, or a combination thereof, to retrieve a request-related device location associated with the user device. The apparatus 200 may include means configured to retrieve the request-related device location in a myriad of ways. In some embodiments, the apparatus 200 may communicate with the user device to retrieve the request-related device location. For example, in some embodiments, the apparatus may request the request-related device location using location services and modules associated with the user device. In other embodiments, the apparatus may request, from the user device, whether the user device is communicable with a known device (e.g., a known Wi-Fi, Bluetooth, or IoT device). For example, the apparatus may request whether the user device is communicable with a particular known Bluetooth device at the location to which the decodable visual representation was mailed (e.g., a known device associated with the user's home address) or posted (e.g., a known device associated with a public location). Additionally or alternatively, in some embodiments, the apparatus 200 may communicate with a carrier device associated with the mobile carrier for the user device to retrieve a request-related device location associated with the user device. For example, the apparatus may cause the carrier device to triangulate the request-related device location associated with the user device, such as by using one or more towers associated with the carrier network.

At block 604, the apparatus 200 includes means, such as location management module 212, communications module 208, processor 202, and/or the like, or a combination thereof, to identify a decodable location associated with the decodable visual representation. The decodable location represents a location associated with the decodable visual representation, for example a location where the decodable visual representation was mailed or posted. In a particular embodiment, the decodable location represents an address associated with a targeted user entity (e.g., a home address where a promotional mailing including the decodable visual representation was sent by the service provider device).

In some embodiments, the apparatus may receive the decodable location as part of an electronic data transmission received from the user device. For example, the decodable location may be encoded by the decodable visual representation as a source identifier or other decoded information, and transmitted as data included in the electronic data transmission from the user device.

In some embodiments, the apparatus may retrieve a stored decodable location as the decodable location for the decodable visual representation. For example, in some embodiments, the apparatus may retrieve the decodable location from a user information repository managed by, or otherwise available to, the apparatus. The decodable location may be retrieved from the user information repository using a user identifier, for example received from the service provider device at an earlier step.

In other embodiments, the apparatus may receive the decodable location from the service provider device. For example, the apparatus may receive the decodable location along with a user information query from the service provider device. The service provider entity via a service provider device may have, for example, stored a decodable location associated with the decodable visual representation when the service provider entity mailed a promotional mailing to a targeted user entity, where the decodable location represents the address to which the promotional mailing was sent. In some embodiments, the service provider device may store the decodable location such that it is retrievable associated with previously known information managed by the service provider device, or with information provided by the user identification and personalization or forwarded from the user device. For example, the service provider device may store the decodable location associated with a user identifier, source identifier, identity-linked device information, or the like.

At determination block 606, the apparatus 200 includes means, such as location management module 212, processor 202, and/or the like, or a combination thereof, to determine whether the request-related device location is within a threshold distance from the decodable location. In some embodiments, the threshold distance is predefined and/or defined at a set number (e.g., 15 miles, 20 miles, 25 miles, 30 miles, 5 kilometers, 15 kilometers, 25 kilometers, or the like). In other embodiments, the threshold distance may be retrieved from a user information repository, the service provider device, or an external information system (as described) based on one or more user preferences associated with the identity-linked device information. In some embodiments, the apparatus may be configured to utilize one or more pre-defined known algorithms to determine whether the request-related device location is within a threshold distance from the decodable location.

At block 608, the apparatus 200 includes means, such as user information management module 214, processor 202, and/or the like, or a combination thereof, to identify user information based on the determination of whether the request-related device location is within the threshold distance from the decodable location. In some embodiments, for example, at least a portion of the user information may depend on whether the request-related device location (e.g., the user device's location at, or near, the time of the electronic data transmission) is within the threshold distance. For example, the user information may include a default shipping location. The shipping location may be defaulted to the decodable location if the determination indicates that the user device is near that location based on the threshold distance (e.g., where the decodable visual representation was included in a promotional mailing sent to a user's home address, and the apparatus determines the user is at/near the home address). However, based on the determination, if the user device is not near the decodable location, the system may instead identify another location to provide as a shipping location (e.g., to an alternative location associated with the user identifier or identity-linked device information, or to the request-related device location).

The user information may additionally include payment method information. In some embodiments, the apparatus may identify default payment method information only when the determination indicates the request-related device location is within the threshold distance from the decodable location (e.g., the user device is near the decodable location, such as near the address to which a promotional mailing including the decodable visual representation was mailed). The default payment method information may be embodied by stored information retrieved by the apparatus from a user information repository, service provider user information retrieved from the service provider device, and/or external user information retrieved from an external information system, for example via the processes described with respect to FIG. 5.

The apparatus may identify that the user information should not include any payment method information if the determination indicates the request-related device location is not within the threshold distance from the decodable location (e.g., the user device is not near an address to which a promotional mailing was sent). By personalizing user information to include certain portions only when the user device is in a trusted area, the likelihood of fraudulent transactions is decreased. For example, the secure technology built into the SIM for mobile phone number identification remains vulnerable to social engineering by a malicious user entity to obtain a new or replacement SIM. However, if a fraudulent user entity accesses the user identification and personalization system from a user device not located near a decodable location (e.g., the home address of the targeted user entity, for example) payment method information may not be automatically provided and thus cannot be fraudulently utilized by the malicious user entity. At the same time, when the user device is at or near an expected location associated with the user device (e.g., the request-related device location is at a decodable location where a promotional mailing was sent, at a home location associated with the user device/user identifier/identity-linked device information, or the like) the apparatus may automatically identify the user information including personalized default payment method information the targeted user entity. The user information may then be transmitted to the service provider device to cause transmission, to the user device, of personalized information and/or interfaces with payment options (or other information) pre-populated based on the user information.

In other embodiments, the apparatus may identify user information that indicates the user entity/user device are authenticated as associated with the decodable location (e.g., a business entity associated with a particular business address, for example). For example, the decodable visual representation may have been mailed from the service provider entity to the decodable location, which may be an address associated with (or believed to be associated with) the user entity, to authenticate the targeted user entity is associated with the mailed location. In such circumstances, the user information may include an entity verified value that represents whether the user entity has been authenticated based on the determination. For example, the apparatus may identify user information including an entity verified value indicating the user entity is authenticated when the determination indicates the request-related device information is within the threshold distance from the decodable location. Alternatively, the apparatus may identify user information including an entity verified value indicating the user entity is not authenticated when the determination indicates the request-related is not within the threshold distance from the decodable location.

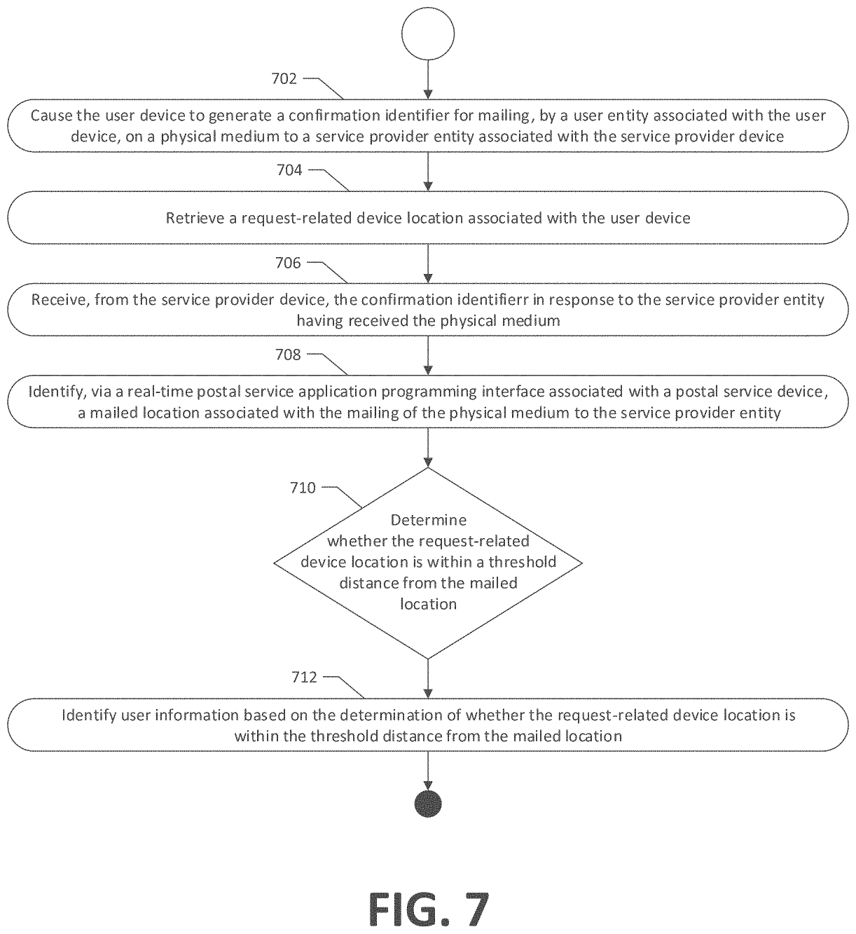

FIG. 7 illustrates an example process for identifying appropriate user information for personalization based on a request-related device location and a mailed location associated with a mailed confirmation identifier, for example performed by a user identification and personalization system embodied by apparatus 200. Some or all of the operations illustrated may, in some embodiments, be performed after the service provider device has received a user identifier and transmitted a user information query to the user identification and personalization system embodied by the apparatus 200.

At block 702, the apparatus 200 includes means, such as service provider request handling module 216, communications module 208, processor 202, and/or the like, or a combination thereof, to cause the user device to generate a confirmation identifier for mailing, by a user entity associated with the user device, on a physical medium to a service provider entity associated with the service provider device. In some embodiments, the apparatus causes the user device to generate the confirmation identifier in response to receiving an electronic data transmission indicative that the user device scanned a decodable visual representation and executed a corresponding access link (e.g., automatically or in response to user engagement with the access link). For example, the decodable visual representation may have, via a mailing that includes the decoded visual representation (e.g., a post card with the decodable visual representation printed on the post card), been sent to a user entity location, such as an address associated with (or believed to be associated with) the user entity.

In some embodiments, the apparatus is configured to generate the confirmation identifier using one or more algorithms. In some embodiments, the algorithm(s) for generating the confirmation identifier may be based on identity-linked device information, a user identifier, and the like. The confirmation identifier may be rendered via the user display of the user device, such that the user entity may view the confirmation identifier and include it on a physical medium (e.g., a letter, postcard, or other mailing).

The confirmation identifier may include an encoded, random, or pseudo-random number that may be used to identify the mailing on which the confirmation identifier was included. In some embodiments, the confirmation identifier is physically written or printed on the physical medium and mailed via a postal service back to the service provider device.

At block 704, the apparatus 200 includes means, such as location management module 212, communications module 208, processor 202, and/or the like, or a combination thereof, to retrieve a request-related device location associated with the user device. The apparatus 200 may include means configured to retrieve the request-related device location in a myriad of ways. In some embodiments, the apparatus 200 may communicate with the user device to retrieve the request-related device location. For example, in some embodiments, the apparatus may request the request-related device location using location services and modules associated with the user device. In other embodiments, the apparatus may request, from the user device, whether the user device is communicable with a known device (e.g., a known Wi-Fi, Bluetooth, or IoT device). For example, the apparatus may request whether the user device is communicable with a particular known Bluetooth device at the location to which the decodable visual representation was mailed (e.g., a known device associated with the user's home address) or posted (e.g., a known device associated with a public location). Additionally or alternatively, in some embodiments, the apparatus 200 may communicate with a carrier device associated with the mobile carrier for the user device to retrieve a request-related device location associated with the user device. For example, the apparatus may cause the carrier device to triangulate the request-related device location associated with the user device, such as by using one or more towers associated with the carrier network.

In some embodiments, the request-related device location associated with the user device is retrieved concurrently, just before, or just after the apparatus causes the user device to generate the confirmation identifier. In other embodiments, the request-related device location associated with the user device is retrieved upon receiving an electronic data transmission indicative that the user device scanned a decodable visual representation and executed a corresponding access link (e.g., automatically or in response to user engagement with the access link).

At block 706, the apparatus 200 includes means, such as service provider request handling module 216, communications module 208, processor 202, and/or the like, or a combination thereof, to receive, from the service provider device, the confirmation identifier in response to the service provider entity having received the physical medium. For example, the service provider entity may have received the physical medium mailed by the user entity to a service provider location associated with the service provider entity. The service provider entity (or, if the service provider entity is a business entity, an employee for example) may input the received confirmation identifier into a service provider device associated with the service provider entity. The service provider device may then transmit the received confirmation identifier to the apparatus embodying the user identification and personalization system. In some embodiments, the service provider device may transmit a user information query including the confirmation identifier, where the user information query represents a request to confirm the user entity associated with the user device is authenticated associated with the an entity location to which the mailing including the decodable visual representation was mailed. The service provider device, in some embodiments, may further transmit additional information, such as a user identifier, source identifier, and/or identity-linked device information associated with the confirmation identifier.

At block 708, the apparatus 200 includes means, such as service provider request handling module 216, location management module 212, communications module 208, processor 202, and/or the like, or a combination thereof, to identify, via a real-time postal service application programming interface associated with a postal service device, a mailed location associated with the mailing of the physical medium to the service provider entity. A real-time postal service application programming interface may provide information associated with the location where a particular mailing was sent. The real-time postal service application programming interface may be managed by a postal service device controlled by a postal service entity that moves and delivers mailings between entities. The mailing service may enter, upon intake of new mailings, a mailed location associated with each mailing via one or more postal service devices and associate that mailed location with a confirmation identifier present on the mailing (e.g., the confirmation identifier provided by the apparatus and written/printed on the mailing by the user entity). Another entity may retrieve the mailed location for a piece of mailing via the real-time postal service application programming interface using the confirmation identifier associated with that mailing. For example, the apparatus may query the postal service device, via the real-time postal service application programming interface and using the confirmation identifier received from the service provider device, for the mailed location associated with the mailing of the physical medium from the user entity to the service provider entity, and receive the mailed location as response data. The mailed location indicates where the user entity deposited the physical mailing to the postal service for mailing (e.g., a post office, a mail drop box, or the like).

At determination block 710, the apparatus 200 includes means, such as location management module 212, processor 202, and/or the like, or a combination thereof, to determine whether the request-related device location is within a threshold distance from the mailed location. In some embodiments, the threshold distance is predefined and/or defined at a set number (e.g., 15 miles, 20 miles, 25 miles, 30 miles, 5 kilometers, 15 kilometers, 25 kilometers, or the like). In other embodiments, the threshold distance may be retrieved from a user information repository, the service provider device, or an external information system (as described) based on one or more user preferences associated with the user identifier/identity-linked device information for the service provider device. In some embodiments, the apparatus may be configured to utilize one or more pre-defined known algorithms to determine whether the request-related device location is within a threshold distance from the decodable location.

Additionally, in some embodiments, the determination at block 710 determines whether the request-related device location is within the predefined threshold (or a second predefined threshold) from the user entity location associated with the user entity. For example, the determination may represent whether, additionally or alternatively, the request-related device location (associated with the scanning of the decodable visual representation) is within a certain radius from the user entity location to which the mailing including the decodable visual representation was mailed.

At block 712, the apparatus 200 includes means, such as user information management module 214, processor 202, and/or the like, or a combination thereof, to identify user information based on the determination of whether the request-related device location is within the threshold distance from the mailed location. In some embodiments, the apparatus may identify user information that indicates the user entity/user device are authenticated as associated with the mailed location or request-related device location (which may be a business entity associated with a particular business address, for example) when the determination indicates the request-related device location is within the threshold distance from the mailed location. In other embodiments, the apparatus may identify user information that indicates the user entity/user device are authenticated as associated with the mailed location or request-related device location when the determination indicates the request-related device location is within the threshold distance from the mailed location, and the request-related device location is within the threshold distance (or a second threshold distance) from the user entity location associated with the user entity. For example, the user information may include an entity verified value that represents whether the user entity has been authenticated based on the determination.

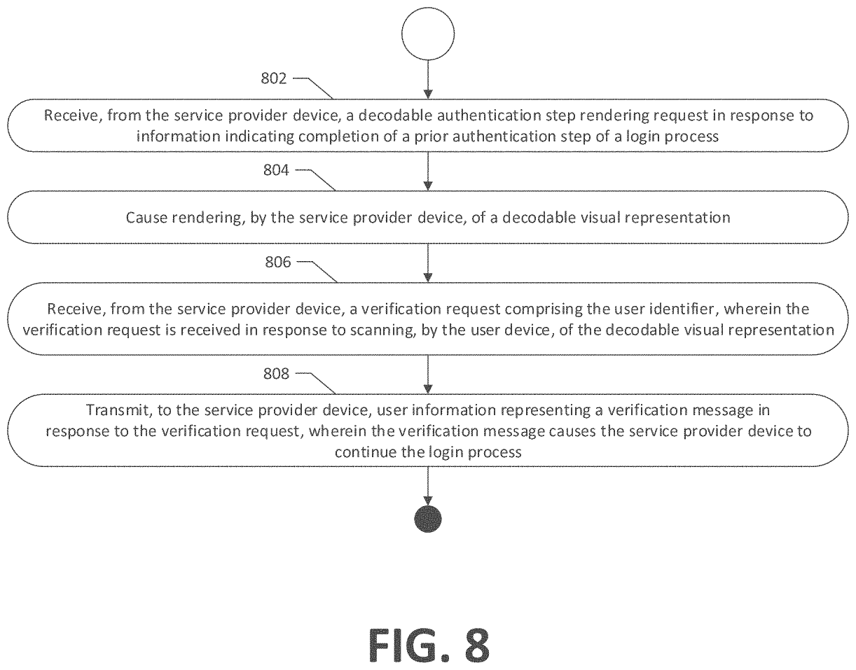

FIG. 8 illustrates an example process for performing a decodable authentication step of a login process via user information associated with identity-linked information received in response to mobile tagging, for example performed by a user identification and personalization system embodied by apparatus 200. Some or all of the operations illustrated may, in some embodiments, be performed after the service provider device has received a user identifier from the user identification and personalization system embodied by the apparatus 200. For example, some or all of the operations may be performed before, concurrently with, or after the operations described with respect to the process illustrated in FIG. 4.

In some embodiments, the login process may include a two- or multi-factor authentication step for accessing the service provider device via user information provided by the apparatus embodying the user identification and personalization system, such as when the service provider device is associated with the user device. For example, the service provider device may be a laptop associated with the user entity, and the user device may be a mobile device (such as a mobile phone) associated with the same user entity. The service provider device may be protected by the login process, such that the user entity may be required to perform multiple authentication steps to successfully access the service provider device. For example, the user entity may be required to perform a two- or multi-factor authentication step by scanning a decodable visual representation before gaining access the service provider device. In some embodiments, for example after the user entity has already submitted a username and password authenticated by the service provider device.

At block 802, the apparatus 200 includes means, such as service provider request handling module 216, communications module 208, processor 202, and/or the like, or a combination thereof, to receive, from the service provider device, a decodable authentication step rendering request in response to information indicating completion of a prior authentication step of a login process. In some embodiments, the login process may include multiple authentication steps (e.g., a primary authentication step and a two-factor authentication step, or a primary authentication step and a plurality of multi-factor authentication steps). The decodable authentication step rendering request may be received, in some embodiments, after the primary authentication step, such as when the user entity successfully enters a username and password. In other embodiments, the decodable authentication step rendering request may be received after the user entity successfully completes another multi-factor authentication step (e.g., a known multi-factor authentication step). The decodable authentication step rendering request may indicate that, to continue, the login process requires a verification message from the apparatus embodying the user identification and personalization system.

At block 804, the apparatus includes means, such as service provider request handling module 216, communications module 208, processor 202, and/or the like, or a combination thereof, to cause rendering, by the service provider device, of a decodable visual representation. The apparatus may cause rendering of the decodable visual representation in response to receiving the decodable authentication step rendering request. In some embodiments, the apparatus may generate the decodable visual representation associated with the service provider device and/or the user device associated with the service provider device, and transmit the decodable visual representation to the service provider device to cause rendering. In some embodiments, the apparatus may retrieve a pre-determined decodable visual representation associated with the service provider device, and transmit the pre-determined decodable visual representation to the service provider device to cause rendering.

The decodable visual representation may be scannable by the user device to perform an identity-linked device information authentication process, and enable the service provider device to request user identification and/or transaction personalization services using a received user identifier. For example, the operations 806 and 808 may be performed after the apparatus performs the process illustrated in FIG. 4, or a subset of operations therein.

At block 806, the apparatus 200 includes means, such as the service provider request handling module 216, communications module 208, processor 202, and/or the like, or a combination thereof, to receive, from the service provider device, a verification request comprising the user identifier, wherein the verification request is received in response to scanning, by the user device, of the decodable visual representation. The user entity may scan the decodable visual representation using a user device, to perform authentication associated with identity-linked device information and provide the service provider device with a user identifier enabling user identification and personalization services via the apparatus. For example, the verification request may be received after the process illustrated with respect to FIG. 4.

In some embodiments, the user entity may scan the decodable visual representation by capturing the decodable visual representation with their user device. In some embodiments, a verification button may be auto-generated based on the information embedded in/encoded by the decodable visual representation. The verification button may function as an access link for transmitting an electronic data transmission to the apparatus embodying the user identification and personalization system and beginning the process illustrated by FIG. 4.

At block 808, the apparatus 200 includes means, such as the user information management module 214, service provider request handling module 216, processor 202, and/or the like, or a combination thereof, to transmit, to the service provider device, user information representing a verification message in response to the verification request, wherein the verification message causes the service provider to continue the login process. The verification message may indicate that the user device scanned the rendered decodable visual representation and was authenticated as associated with the service provider device. In some embodiments, the apparatus may retrieve user information representing a verification message from a user information repository managed by, or otherwise accessible to, the apparatus. For example, using the user identifier, the apparatus may retrieve one or more records indicating that the user device is associated with the service provider device (e.g., that both devices are owned by a single user entity). Thus, upon receiving the transmitted verification message, the service provider device confirms that the apparatus has completed this authentication step, and may continue the login process.

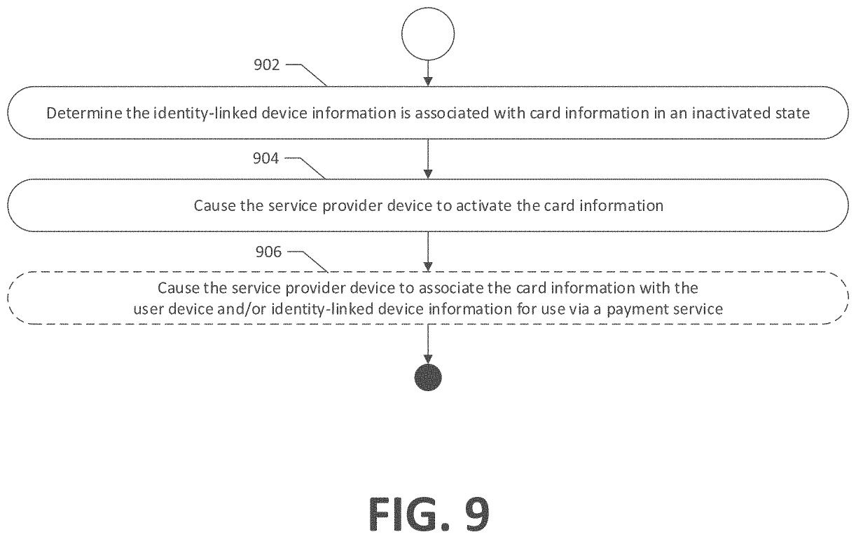

FIG. 9 illustrates an example process for activating card information associated with a newly received credit/debit card via a user identification and personalization system using identity-linked device information, for example performed by a user identification and personalization system embodied by apparatus 200. Some or all of the operations illustrated may, in some embodiments, be performed after the service provider device has received a user identifier from the user identification and personalization system embodied by the apparatus 200.

At block 902, the apparatus 200 includes means, such as user information management module 214, identity-linked device information management module 210, service provider request handling module 216, processor 202, and/or the like, or a combination thereof, to determine the identity-linked device information is associated with card information in an inactivated state. For example, the apparatus may retrieve service provider user information representing card information and/or activation state from the service provider device, or from an external information system. For example, the apparatus may communicate with an external information system associated with a card issuer to retrieve external user information that represents the card information and activation state. The external user information may be retrieved using the identity-linked device information, or a user identifier associated with the identity-linked device information.

At block 904, the apparatus 200 includes means, such as communications module 208, user information management module 214, service provider request handling module 216, processor 202, and/or the like, or a combination thereof, to cause the service provider device to activate the card information. In some embodiments, the apparatus may transmit a card activation message to the service provider device. The card activation message may include the identity-linked device information or user identifier, and the card information to be activated. The card activation message may be transmitted to the service provider device via an API configured to activate the card information (e.g., by setting an activation status to an activated status) such that the new card information may be used for transactions. For example, once the card information is activated, a user entity may utilize the new credit/debit card for purchasing.

In some embodiments, after the card information is enabled, the user device may be automatically enrolled in a payment service. The payment service may be enrolled such that the user device may be used to complete purchases in lieu of inputting the credit or debit card.

At optional block 906, for example, the apparatus includes means, such as communications module 208, user information management module 214, service provider request handling module 216, processor 202, and/or the like, or a combination thereof, to cause the service provider device to associate the card information with the user device and/or identity-linked device information for use via a payment service. For example, the service provider device may be configured to manage enrollment in the payment service. Alternatively or additionally, the service provider may be configured to transmit new enrollment requests to another device (e.g., a payment service device associated with the payment service). In some embodiments, the payment service may be a mobile payment processing service for performing transactions via a mobile device. For example, the payment service may be Apple Pay®, Google Pay™, or the like.

In some embodiments, the apparatus may generate a payment service enrollment message including the card information and a user device identifier (e.g., an IMEI, serial number, or the like) and/or the identity-linked device information. The payment service enrollment message may be transmitted to the service provider device, for example via an application programming interface, to enroll the user device for using card information with the payment service. For example, if the payment service enrollment message includes the card information and the user device identifier, the user device may be utilized to perform transactions via the payment service. If the user entity obtains a new device, the new device will not be enrolled to use the payment service automatically. If the payment service enrollment message includes the card information and the identity-linked device information, the user device may be utilized to perform transactions via the payment service as long as the user device remains associated with the identity-linked device information. If, for example, the identity-linked device information is a mobile phone number, and the user receives a new device utilizing the same mobile phone number, the new device may be automatically permissioned to utilize the payment service.

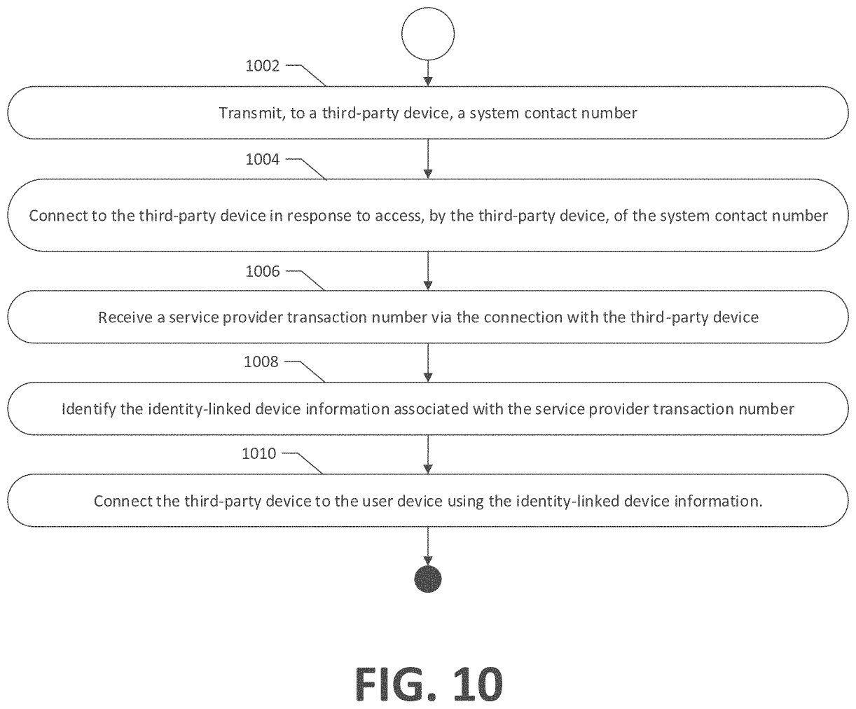

FIG. 10 illustrates an example process for connecting a third-party device to a user device via a user identification and personalization system using identity-linked device information without exposing personally identifying information, for example performed by a user identification and personalization system embodied by apparatus 200. Some or all of the operations illustrated may, in some embodiments, be performed after the service provider device has received a user identifier from the user identification and personalization system embodied by the apparatus 200.

At block 1002, the apparatus 200 includes means, such as service provider request handling module 216, communications module 208, processor 202, and/or the like, or a combination thereof, to transmit, to a third-party device, a system contact number. In some embodiments, the third-party device may be a mobile device operated by a third-party entity. The third-party device may be associated with the service provider device, for example where the third-party device is utilized in completing transactions between the user device and the service provider device. For example, the mobile device may be operated by a delivery driver performing a delivery of an item associated with a completed transaction between the user device and the service provider device (e.g., an item purchased by the user entity via the user device).

IN some embodiments, the apparatus may transmit the system contact number directly to the third-party device. Alternatively, in some embodiments, the apparatus may transmit the system contact number to the service provider device for forwarding to the third-party device, and the third-party device may communicate with the service provider device to retrieve the system contact number from the service provider device. In some embodiments, the service provider device may store the system contact number for forwarding to one or more third-party devices in response to future requests.

In some embodiments, the system contact number is a telephone number for accessing the apparatus embodying the user identification and personalization system. Using the telephone number, the third-party device may connect/communicate with the apparatus by dialing the system contact number.

At block 1004, the apparatus includes means, such as service provider request handling module 216, communications module 208, processor 202, and/or the like, to connect to the third-party device in response to access, by the third-party device, of the system contact number. For example, the apparatus may connect to the third-party device via a VOIP or telephone connection in response a third-party entity accessing the system contact number (e.g., by dialing the system contact number via the third-party device).

At block 1006, the apparatus includes means, such as service provider request handling module 216, communications module 208, processor 202, and/or the like, to receive a service provider transaction number via the connection with the third-party device. In some embodiments, the service provider transaction number represents a transaction identifier or order number for a completed transaction between the user device and the service provider device. In some embodiments, the service provider transaction number may be input by a third-party entity via the third-party device. For example, the third-party entity may input, via a keyboard, touch screen, voice commands, or the like, the service provider transaction number. The third-party entity may have received the service provider transaction number at the beginning of the delivery process, or may be able to retrieve it from the service provider device (e.g., using an API) or through communication with the service provider entity (e.g., contacting the service provider entity).

At block 1008, the apparatus 200 includes means, such as identity-linked device information management module 210, processor 202, and/or the like, or a combination thereof, to identify the identity-linked device information associated with the service provider transaction number. In some embodiments, the identity-linked device information may be identified by retrieving the identity-linked device information from a repository managed, or accessible to the apparatus, for example a user information repository and/or identity-linked device information repository, using the service provider transaction number. For example, a user information repository may store a transaction history (e.g., including one or more historical service provider transaction number(s)) associated with the identity-linked device information. The apparatus may query for the identity-linked device information associated with the service provider transaction number such that the identity-linked device information may be retrieved based on a service provider transaction number received from the third-party device, such as the identity-linked device information associated with a transaction history that includes the service provider transaction number.

At block 1010, the apparatus 200 includes means, such as service provider request handling module 216, communications module 208, processor 202, and/or the like, or a combination thereof, to connect the third-party device to the user device using the identity-linked device information. In some embodiments, the apparatus may forward the connection established with the third-party device to the user device. For example, the apparatus may forward a call from the third-party device to the user device. The third-party device and user device may be connected without exposing the identity-linked device information (or other personally identifiable information) to the third-party device.

### CONCLUSION

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the disclosure set forth herein will come to mind to one skilled in the art to which these inventions pertain having the benefit of the teachings presented in the foregoing description and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A user identification and personalization system for validating user identity based on identity-linked device information and providing a user identifier associated with the identity-linked device information for transaction personalization, wherein the user identification and personalization system comprises at least one processor and at least one memory, the at least one memory having computer-coded instructions therein, wherein the computer-coded instructions are configured to, in execution with the at least one processor, cause the user identification and personalization system to:
receive, via a carrier network, at the user identification and personalization system from a user device, an electronic data transmission, the electronic data transmission comprising identity-linked device information, the carrier network comprising at least a carrier device, the carrier device configured to inject the electronic data transmission with identity-linked device information via a header enrichment process, wherein the electronic data transmission is indicative of prior execution, by the user device identified by the identity-linked device information, of an access link having been detected and decoded from a decodable visual representation and having caused the user device to execute the access link;
determine a user identifier based on the identity-linked device information; and
transmit, to the user device, an authentication indication comprising at least the user identifier, the authentication indication configured to cause the user device to forward the user identifier to a service provider device.

2. The user identification and personalization system of claim 1, wherein the computer-coded instructions further cause the user identification and personalization system to:
receive, from the service provider device, a user information query comprising at least the user identifier;
retrieve, from a user information repository, stored user information associated with the user identifier; and
transmit, to the service provider device, user information comprising at least a portion of the stored user information.

3. The user identification and personalization system of claim 1, wherein the computer-coded instructions further cause the user identification and personalization system to:
transmit, to at least one external information system, at least one external information request;
receive external user information from the at least one external information system in response to the at least one external information request; and
transmit, to the service provider device, user information comprising at least a portion of the external user information.

4. The user identification and personalization system of claim 1, wherein the authentication indication comprises a redirect link comprising the user identifier, the redirect link configured to cause the user device to transmit the user identifier to the service provider device.

5. The user identification and personalization system of claim 1, wherein the computer-coded instructions configured are further configured to cause the user identification and personalization system to:
retrieve a request-related device location associated with the user device;
identify a decodable location associated with the decodable visual representation;
determine whether the request-related device location is within a threshold distance from the decodable location;
identify user information based on the determination of whether the request-related device location is within the threshold distance from the decodable location; and
transmit the user information to the service provider device in response to a user information query.

6. The user identification and personalization system of claim 5, wherein the computer-coded instructions configured to retrieve a request-related device location associated with the user device cause the user identification and personalization system to:
retrieve, from the user device, a known device indication indicative of whether the user device is communicable with a known device; and
determine the known device indication indicates the user device is communicable with the known device.

7. The user identification and personalization system of claim 1, wherein the identity-linked device information comprises a mobile phone number associated with the user device, and wherein the computer-coded instructions are further configured to cause the user identification and personalization system to:
transmit, to device third-party device, a system contact number;
connect to the third-party device;
receive a service provider transaction number via the connection with the third-party device;
identify the identity-linked device information is associated with the service provider transaction number; and
connect the third-party device to the user device using the identity-linked device information.

8. The user identification and personalization system of claim 1, wherein the user device is associated with a user entity, and wherein the service provider device is associated with a service provider entity, wherein the computer-coded instructions are further configured to cause the user identification and personalization system to:
cause the user device to generate a confirmation identifier for mailing, by the user entity associated with the user device, on a physical medium to the service provider entity associated with the service provider device;
retrieve a request-related device location associated with the user device;
receive, from the service provider device, the confirmation identifier in response to the service provider entity having received the physical medium;
identify, via a real-time postal service application programming interface associated with a postal service device, a mailed location associated with the mailing of the physical medium to the service provider entity;
determine whether the request-related device location is within a threshold distance from the mailed location;
identify user information based on the determination of whether the request-related device location is within the threshold distance from the mailed location; and
transmit the user information to the service provider device in response to a user information query.

9. The user identification and personalization system of claim 1, wherein the user device comprises a first user device, the service provider device comprises a second user device associated with the first user device, and wherein the computer-coded instructions further are further configured to cause the user identification and personalization system to:
receive, from the service provider device, a decodable authentication step rendering request in response to information indicating completion of a prior authentication step of a login process;
cause rendering, by the service provider device, of the decodable visual representation;
receive, from the service provider device, a verification request comprising the user identifier, wherein the verification request is received in response to scanning, by the user device, of the decodable visual representation; and
transmit, to the service provider device, user information representing a verification message in response to the verification request, wherein the verification message causes the service provider device to continue the login process.

10. The user identification and personalization system of claim 1, wherein the computer-coded instructions are further configured to cause the user identification and personalization system to:
determine the identity-linked device information is associated with card information in an inactivated state; and
cause the service provider device to activate the card information.

11. The user identification and personalization system of claim 10, wherein the computer-coded instructions are further configured to cause the user identification and personalization system to:
cause the service provider device to associate the card information with the identity-linked device information for use via a payment service.

12. The user identification and personalization system of claim 1, wherein the electronic data transmission further comprises a source identifier, and wherein the computer-coded instructions are further configured to cause the user identification and personalization system to:
authenticate the identity-linked device information matches the source identifier.

13. The user identification and personalization system of claim 1, wherein the identity-linked device information comprises a mobile telephone number in a plaintext format or a hashed format.

14. A computer-implemented method for validating user identity-linked device information and providing a user identifier associated with the identity-linked device information for transaction personalization, the method comprising:
receiving, via a carrier network, at the user identification and personalization system from a user device, an electronic data transmission, the electronic data transmission comprising identity-linked device information, the carrier network comprising at least a carrier device, the carrier device configured to inject the electronic data transmission with identity-linked device information via a header enrichment process, wherein the electronic data transmission is indicative of prior execution, by the user device identified by the identity-linked device information, of an access link having been detected and decoded from a decodable visual representation and having caused the user device to execute the access link;
determining a user identifier based on the identity-linked device information; and
transmitting, to the user device, an authentication indication comprising at least the user identifier, the authentication indication configured to cause the user device to forward the user identifier to a service provider device.

15. The computer-implemented method of claim 14, further comprising:
receiving, from the service provider device, a user information query comprising at least the user identifier;
retrieving, from a user information repository, stored user information associated with the user identifier; and
transmitting, to the service provider device, user information comprising at least a portion of the stored user information.

16. The computer-implemented method of claim 14, further comprising:
transmitting, to at least one external information system, at least one external information request;
receiving external user information from the at least one external information system in response to the at least one external information request; and
transmitting, to the service provider device, user information comprising at least a portion of the external user information.

17. The computer-implemented method of claim 14, further comprising:
retrieving a request-related device location associated with the user device;
identifying a decodable location associated with the decodable visual representation;
determining whether the request-related device location is within a threshold distance from the decodable location;
identifying user information based on the determination of whether the request-related device location is within the threshold distance from the decodable location; and
transmitting the user information to the service provider device in response to a user information query.

18. The computer-implemented method of claim 14, wherein the electronic data transmission further comprises a source identifier, and the method further comprising:
authenticating the identity-linked device information matches the source identifier.

19. The computer-implemented method of claim 14, wherein the identity-linked device information comprises a mobile telephone number in a plaintext format or a hashed format.

20. A computer program product for validating user identity based on identity-linked device information and providing a user identifier associated with the identity-linked device information for transaction personalization, the computer program product comprising a non-transitory computer readable storage medium having computer program instructions stored therein, the computer program instructions configured to, when executed by a processor, cause the processor to:
receive, via a carrier network, at the user identification and personalization system from a user device, an electronic data transmission, the electronic data transmission comprising identity-linked device information, the carrier network comprising at least a carrier device, the carrier device configured to inject the electronic data transmission with identity-linked device information via a header enrichment process, wherein the electronic data transmission is indicative of prior execution, by the user device identified by the identity-linked device information, of an access link having been detected and decoded from a decodable visual representation and having caused the user device to execute the access link;
determine a user identifier based on the identity-linked device information; and
transmit, to the user device, an authentication indication comprising at least the user identifier, the authentication indication configured to cause the user device to forward the user identifier to a service provider device.
